(19) United States
(12) Patent Application Publication
(10) Pub. No.: US 2021/0370208 A1
(43) Pub. Date: Dec. 2, 2021

(54) FILTER MEDIA COMPRISING POLYAMIDE FIBERS

(71) Applicant: Hollingsworth & Vose Company, East Walpole, MA (US)

(72) Inventors: Praveen Kumar Yegya-Raman, Nashua, NH (US); Sneha Swaminathan, Merrimack, NH (US)

(73) Assignee: Hollingsworth & Vose Company, East Walpole, MA (US)

(21) Appl. No.: 16/884,113

(22) Filed: May 27, 2020

(51) Int. Cl. B01D 39/16; B01D 39/20

(52) U.S. Cl. CPC B01D 39/1623; B01D 39/1676; B01D 39/2017; B01D 2239/1233; B01D 2239/1291; B01D 2239/1216; B01D 2239/0631; B01D 2239/0428; B01D 2239/1258; B01D 2239/1266

(57) ABSTRACT

Filter media, including those suitable for hydraulic, fuel, HVAC, HEPA, and/or other applications, and related methods are provided. In some embodiments, a filter media described herein may include a layer (e.g., a fine fiber layer) comprising a plurality of fibers comprising polyamide 11. In some embodiments, a filter media comprises a layer (e.g., a fine fiber layer) comprising a plurality of electrospun fibers comprising a material having one or more advantageous properties. In an exemplary set of embodiments, the plurality of fibers comprise polyamide 11 (e.g., Nylon 11). In some embodiments, the polyamide 11 fibers are produced by an electrospinning process.

### FIELD OF INVENTION

The present embodiments relate generally to filter media, and specifically, to filter media comprising fibers e.g., comprising polyamide 11. In some cases, the fibers are electrospun.

### BACKGROUND

Filter media can be used to remove contamination in a variety of applications such as those involving fuel, hydraulics, HVAC, and air filtration. In general, filter media include one or more fiber webs. The fiber web provides a porous structure that permits fluid (e.g., air or liquid) to flow through the web. Contaminant particles (e.g., dust particles, soot particles) contained within the fluid may be trapped on the fiber web. Fiber web characteristics (e.g., pore size, fiber dimensions, fiber composition, basis weight, amongst others) affect filtration performance of the media.

Although different types of filter media are available, improvements are needed.

### SUMMARY OF THE INVENTION

Filter media comprising fibers comprising polyamide 11 and related methods are generally provided. The subject matter of this application involves, in some cases, interrelated products, alternative solutions to a particular problem, and/or a plurality of different uses of structures and compositions.

In one aspect, filter media are provided. In some embodiments, the filter media comprises a fine fiber layer comprising a plurality of electrospun fibers, the electrospun fibers comprising polyamide 11, and a support layer adjacent the fine fiber layer.

In some embodiments, the filter media comprises a fine fiber layer comprising a plurality of fibers comprising polyamide 11 and a support layer adjacent the fine fiber layer, wherein the plurality of fibers have an average diameter of less than or equal to 1.5 microns.

In some embodiments, the filter media comprises a fine fiber layer comprising a plurality of fibers comprising polyamide 11, the fine fiber layer having a solidity of greater than or equal to 10.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic diagram showing a cross-section of an exemplary filter media according to one set of embodiments;

FIG. 1B is a schematic diagram showing a cross-section of an exemplary filter media according to one set of embodiments;

FIG. 2 is a plot showing fiber diameter of exemplary fibers versus type of solvent used to form the fibers, according to one set of embodiments;

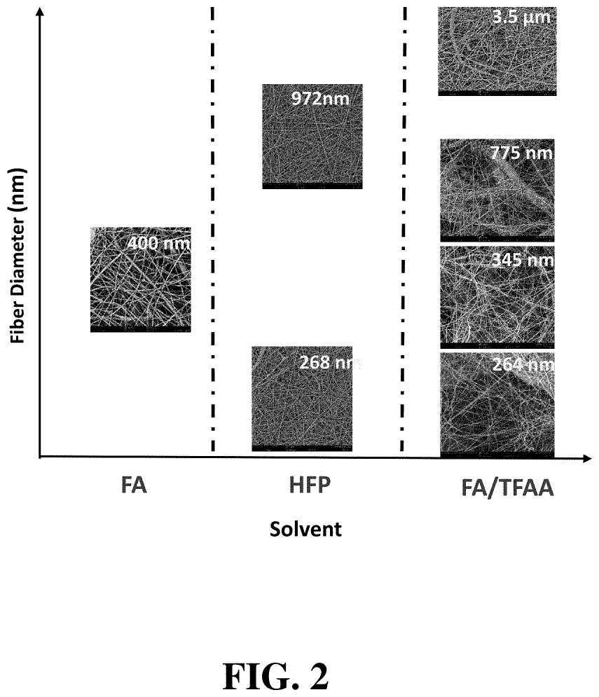

FIG. 3 is a plot of pressure drop versus time for an exemplary filter media as compared to comparative filter media, according to one set of embodiments;

FIG. 4 is a plot of Fuel Water Separation (FWS) efficiency for exemplary filter media as compared to comparative filter media, according to one set of embodiments;

FIG. 5 is a plot of fuel efficiency for exemplary filter media as compared to comparative filter media, according to one set of embodiments;

FIGS. 6A-6F are schematic diagrams showing cross-sections of exemplary filter media (e.g., for fuel applications), according to one set of embodiments;

FIGS. 7A-7D are schematic diagrams showing cross-sections of exemplary filter media (e.g., for hydraulic applications), according to one set of embodiments; and

FIGS. 8A-8B are schematic diagrams showing cross-sections of exemplary filter media (e.g., for HEPA applications), according to one set of embodiments.

### DETAILED DESCRIPTION

Filter media, including those suitable for hydraulic, fuel, HVAC, HEPA, and/or other applications, and related methods are provided. In some embodiments, a filter media described herein may include a layer (e.g., a fine fiber layer) comprising a plurality of fibers comprising polyamide 11. In some embodiments, a filter media comprises a layer (e.g., a fine fiber layer) comprising a plurality of electrospun fibers comprising a material having one or more advantageous properties. In an exemplary set of embodiments, the plurality of fibers comprise polyamide 11 (e.g., Nylon 11). Polyamide 11 is produced, in some embodiments, by polymerization of 11-aminoundecanoic acid (e.g., which is derived from castor beans). In some embodiments, the polyamide 11 fibers are produced by an electro spinning process. Fine fiber layers comprising polyamide 11 can also be produced using other solution spun process including, for example, centrifugal spinning and/or by extrusion process. In an exemplary set of embodiments, production is using an electrospinning process. Electrospinning can be needle or needless electrospinning.

Filter media comprising a plurality of fibers comprising electrospun fibers such as electrospun polyamide 11 fibers offer several advantages over alternative filter media. For example, advantageously, and without being bound by theory, filter media comprising polyamide 11 fibers produced by electrospinning as described herein may have enhanced properties as compared to polyamide fibers formed by alternative processes such as meltblown processes. In some embodiments, electrospun polyamide 11 fibers may have fiber diameters significantly smaller than those produced by other methods such as meltblowing. While much of this description relates to polyamide 11 fibers, other types of polyamide based fibers may also be present in the filter media and/or may be electrospun. Advantageously, polyamide 11 fibers such as electrospun polyamide 11 fibers are bio-derived and/or may have enhanced properties as compared to other types of fibers such as other types of polyamide fibers (e.g., whether electrospun or produced by other processes) such as high thermal resistance, robustness to swelling, high elongation, low moisture, and/or desirable chemical compatibility.

In some embodiments, the plurality of fibers comprising polyamide 11 are formed via a meltblowing or extrusion process.

In some embodiments, the plurality of fibers described herein (e.g., electrospun polyamide 11 fibers) may have a tunable fiber diameter. Without wishing to be bound by theory, the type and/or ratio of solvents, relative humidity, and/or concentration of components within the electrospinning process may produce fibers having desirable diameters. Fiber diameters are described in more detail, below.

In some embodiments, the fine fiber layers comprising a plurality of fibers described herein advantageously have desirable properties such as high elongation, are hydrophobic, and/or have a desirable solidity and/or thickness.

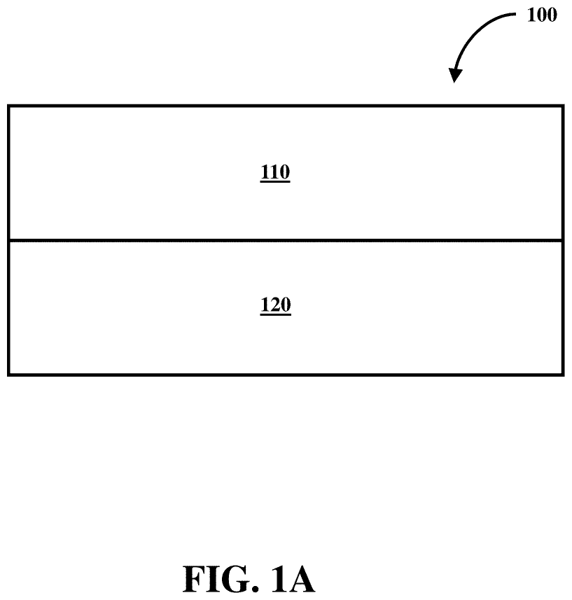

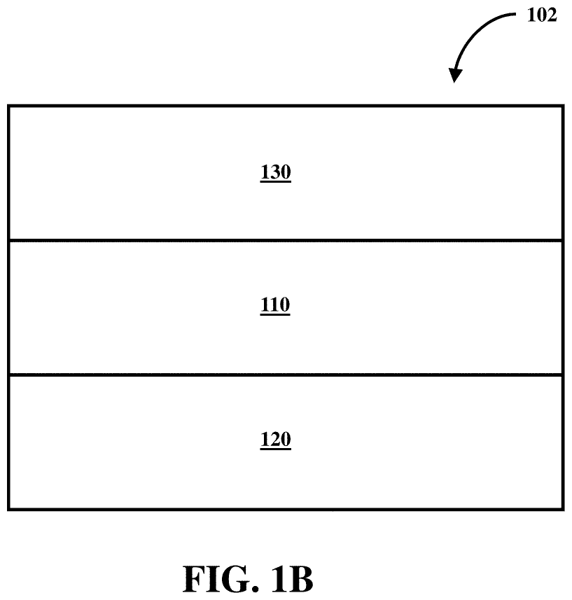

A non-limiting example of a filter media including a fine fiber layer is shown in FIG. 1A. As shown illustratively in FIG. 1A, a filter media 100, shown in cross section, may include a first layer 110 (e.g., a fine fiber layer) that includes a plurality of fibers (e.g. a plurality of electrospun fibers comprising polyamide 11), and a second layer 120 (e.g., a support layer) adjacent first layer 110. In some cases, first layer110 may be directly adjacent (i.e., in direct contact with at least a portion of) second layer 120. In other cases, second layer 120 may be positioned upstream or downstream of, but not in contact with, first layer 110. In some embodiments, first layer 110 is a fine fiber layer that includes a plurality of polyamide 11 fibers having an average diameter of less than or equal to 1.5 microns. In some embodiments, the first layer 110 is a fine fiber layer that includes polyamide 11 fibers and has a void volume of greater than or equal to 60%.

As used herein, when a layer is referred to as being “adjacent” another layer, it can be directly adjacent to the layer, or an intervening layer also may be present. A layer that is “directly adjacent” another layer means that no intervening layer is present.

As described above, some filter media include a layer (e.g., a fine fiber layer) comprising electrospun fibers. In some embodiments, the fine fiber layer comprises fibers formed by an electrospinning process (e.g., electrospun fibers). In some embodiments, the fine fiber layer serves as the efficiency layer for the filter media. In other words, it may contribute appreciably to the filtration performance of the filter media.

Some filter media described herein comprise two or more fine fiber layers. For example, the filter media may comprise two or more fine fiber layers, each fine fiber layer comprising electrospun fibers. It should be understood that any individual fine fiber layer comprising electrospun fibers may independently have some or all of the properties described below with respect to layers comprising electrospun fibers. It should also be understood that a filter media may comprise two fine fiber layers comprising electrospun fibers that are identical and/or may comprise two or more fine fiber layers comprising electrospun fibers that differ in one or more ways.

When present, a layer comprising a plurality of electrospun fibers typically takes the form of a non-woven fiber web comprising a plurality of electrospun fibers (e.g., an electrospun non-woven fiber web).

In some embodiments, some filter media include a fine fiber layer comprising a plurality of fibers such as electrospun fibers. In some embodiments, the plurality of fibers (e.g., plurality of electrospun fibers) comprise a polyamide such as polyamide 11. In some embodiments, the plurality of fibers comprise a blend of polyamides. For example, in some embodiments, the blend of polyamides comprises polyamide 11 blended with one or more types of non-bio derived polyamides. Non-limiting examples of non-bio derived polyamides include polyamide 12, polyamide 6,10, polyamide 6,6, polyamide 6, and copolymers thereof. In an exemplary set of embodiments, the plurality of fibers comprise polyamide 11. In another exemplary set of embodiments, the plurality of fibers are electrospun fibers comprising polyamide 11.

In some embodiments, the filter media includes a fine fiber layer comprising a plurality of fibers comprising polyamide 11, and a second layer (e.g., a support layer, an additional layer) comprising a non-bio derived polyamide.

Advantageously, and without wishing to be bound by theory, polyamide 11 is generally bio-derived such that is can be made from renewable resources (e.g., derived from castor beans). Those of ordinary skill in the art would understand, based upon the teachings of this specification, how to select suitable methods for producing polyamide 11 (e.g., through a bio-derived process).

In some embodiments, fibers comprising polyamide 11 are present in the fine fiber layer in an amount greater than or equal to 80 wt %, greater than or equal to 85% wt %, 90 wt %, greater than or equal to 92 wt %, greater than or equal to 94 wt %, greater than or equal to 96 wt %, greater than or equal to 98 wt %, or greater than or equal to 99 wt % versus the total weight of the fibers in the fine fiber layer. In some embodiments, fibers comprising polyamide 11 are present in the fine fiber layer in an amount less than or equal to 100 wt %, less than or equal to 99 wt %, less than or equal to 98 wt %, less than or equal to 96 wt %, less than or equal to 94 wt %, less than or equal to 92 wt %, less than or equal to 90 wt %, or less than or equal to 85 wt % versus the total weight of the fibers in fine fiber layer. Combinations of the above-referenced ranges are also possible (e.g., greater than or equal to 90 wt % and less than or equal to 100 wt %). Other ranges are also possible. In an exemplary set of embodiments, the fibers comprising polyamide 11 are present in an amount of 100 wt % versus the total weight of the fibers in the fine fiber layer.

The plurality of fibers (e.g., the plurality of electro spun fibers, the plurality of fibers comprising polyamide 11) may have a variety of suitable average largest cross-sectional dimension (e.g., diameter). In some embodiments, a fine fiber layer comprises a plurality of fibers having an average diameter of greater than or equal to 10 nm, greater than or equal to 50 nm, greater than or equal to 100 nm, greater than or equal to 150 nm, greater than or equal to 200 nm, greater than or equal to 250 nm, greater than or equal to 300 nm, greater than or equal to 350 nm, greater than or equal to 400 nm, greater than or equal to 450 nm, greater than or equal to 500 nm, greater than or equal to 550 nm, greater than or equal to 600 nm, greater than or equal to 650 nm, greater than or equal to 700 nm, greater than or equal to 750 nm, greater than or equal to 800 nm, greater than or equal to 900 nm, greater than or equal to 1000 nm, greater than or equal to 1100 nm, greater than or equal to 1250 nm, greater than or equal to 1500 nm, greater than or equal to 2000 nm, greater than or equal to 2500 nm, greater than or equal to 3000 nm, greater than or equal to 3500 nm, greater than or equal to 4000 nm, greater than or equal to 4500 nm, greater than or equal to 5000 nm, or greater than or equal to 5500 nm. In some embodiments, a fine fiber layer comprises a plurality of fibers having an average largest cross-sectional dimension (e.g., diameter) of less than or equal to 6000 nm, less than or equal to 5500 nm, less than or equal to 5000 nm, less than or equal to 4500 nm, less than or equal to 4000 nm, less than or equal to 3500 nm, less than or equal to 3000 nm, less than or equal to 2500 nm, less than or equal to 2000 nm, less than or equal to 1500 nm, less than or equal to 1250 nm, less than or equal to 1100 nm, less than or equal to 1000 nm, less than or equal to 900 nm, less than or equal to 800 nm, less than or equal to 750 nm, less than or equal to 700 nm, less than or equal to 650 nm, less than or equal to 600 nm, less than or equal to 550 nm, less than or equal to 500 nm, less than or equal to 450 nm, less than or equal to 400 nm, less than or equal to 350 nm, less than or equal to 300 nm, less than or equal to 250 nm, less than or equal to 200 nm, less than or equal to 150 nm, less than or equal to 125 nm, less than or equal to 100 nm, or less than or equal to 50 nm. Combinations of the above-referenced ranges are also possible (e.g., greater than or equal to 10 nm and less than or equal to 6000 nm, greater than or equal to 150 nm and less than or equal to 300 nm, greater than or equal to 100 nm and less than or equal to 250 nm, or greater than or equal to 300 nm and less than or equal to 750 nm). Other ranges are also possible. In embodiments in which more than one fine fiber layer is present, each fine fiber layer may independently comprise a plurality of nanofibers having an average diameter in one or more of the ranges described above.

In an exemplary set of embodiments, a fuel filtration component comprising a fine fiber layer as described herein may have a plurality of fibers having an average diameter as described above (e.g., greater than or equal to 10 nm and less than or equal to 6000 nm, greater than or equal to 150 nm and less than or equal to 300 nm). In another exemplary set of embodiments, a hydraulic filtration component comprising a fine fiber layer as described herein may have a plurality of fibers having an average diameter as described above (e.g., greater than or equal to 50 nm and less than or equal to 6000 nm, greater than or equal to 300 nm and less than or equal to 750 nm). In yet another exemplary set of embodiments, a heating ventilation and air conditioning (HVAC) component comprising a fine fiber layer as described herein may have a plurality of fibers having an average diameter as described above (e.g., greater than or equal to 10 nm and less than or equal to 6000 nm, greater than or equal to 100 nm and less than or equal to 250 nm). In yet another exemplary set of embodiments, a high-efficiency particulate air (HEPA) component comprising a fine fiber layer as described herein may have a plurality of fibers having an average diameter as described above (e.g., greater than or equal to 510 nm and less than or equal to 6000 nm, greater than or equal to 10 nm and less than or equal to 250 nm).

The plurality of fibers of the fine fiber layer may be continuous. Continuous fibers are generally made by a “continuous” fiber-forming process, such as a meltblown process, a meltspun, a melt electrospinning, a solvent electrospinning, a centrifugal spinning process, or a spunbond process. In an exemplary set of embodiments, the plurality of fibers of the fine fiber layer are formed by an electrospinning (e.g., a melt electrospinning, a solvent electrospinning) process. In certain embodiments, the continuous fibers described herein have an average length of greater than 125 mm.

In some embodiments, the fine fiber layer comprises a plurality of fibers (e.g., a plurality of electrospun fibers, a plurality of fibers comprising polyamide 11) having an average length. In certain embodiments, the plurality of fibers in the fine fiber layer may have an average length of greater than about 125 mm, greater than or equal to about 200 mm, greater than or equal to about 400 mm, greater than or equal to about 50 mm, greater than or equal to about 750 mm, greater than or equal to about 1 m, greater than or equal to about 2 m, greater than or equal to about 5 m, greater than or equal to about 10 m, greater than or equal to about 20 m, greater than or equal to about 50 m, greater than or equal to about 100 m, greater than or equal to about 250 m, greater than or equal to about 500 m, or greater than or equal to about 750 m. In some instances, the fibers may have an average length of less than or equal to about 1000 m, less than or equal to about 750 m, less than or equal to about 500 m, less than or equal to about 250 m, less than or equal to about 125 m, less than or equal to about 100 m, less than or equal to about 50 m, less than or equal to about 20 m, less than or equal to about 10 m, less than or equal to about 5 m, less than or equal to about 2 m, less than or equal to about 1 m, less than or equal to about 750 mm, less than or equal to about 500 mm, less than or equal to about 400 mm, or less than or equal to about 200 mm. Combinations of the above-referenced ranges are also possible (e.g., greater than or equal to about 125 mm and less than or equal to about 100 meters). Other ranges are also possible.

The fine fiber layer, as described herein, may have certain structural characteristics, such as basis weight and/or solidity. For instance, in some embodiments, the fine fiber layer may have a basis weight of greater than or equal to 0.05 g/m², greater than or equal to 0.1 g/m², greater than or equal to 0.15 g/m², greater than or equal to 0.2 g/m², greater than or equal to 0.3 g/m², greater than or equal to 0.4 g/m², greater than or equal to 0.5 g/m², greater than or equal to 1 g/m², greater than or equal to 2 g/m², greater than or equal to 3 g/m², greater than or equal to 4 g/m², greater than or equal to 5 g/m², greater than or equal to 6 g/m², greater than or equal to 7 g/m², greater than or equal to 8 g/m², greater than or equal to 10 g/m², greater than or equal to 25 g/m², greater than or equal to 50 g/m², greater than or equal to 75 g/m², or greater than or equal to 95 g/m². In some instances, the fine fiber layer may have a basis weight of less than or equal to 100 g/m², less than or equal to 75 g/m², less than or equal to 50 g/m², less than or equal to 25 g/m², less than or equal to 15 g/m², less than or equal to 10 g/m², less than or equal to 9 g/m², less than or equal to 8 g/m², less than or equal to 7 g/m², less than or equal to 6 g/m², less than or equal to 5 g/m², less than or equal to 4 g/m², less than or equal to 3 g/m², less than or equal to 2 g/m², less than or equal to 1.5 g/m², less than or equal to 1 g/m², less than or equal to 0.5 g/m², less than or equal to 0.4 g/m², less than or equal to 0.3 g/m², less than or equal to 0.2 g/m², less than or equal to 0.15 g/m², less than or equal to 0.1 g/m², or less than or equal to 0.075 g/m². Combinations of the above-referenced ranges are also possible (e.g., a basis weight of greater than or equal to 0.2 g/m² and less than or equal to 10 g/m², a basis weight of greater than or equal to 0.5 g/m² and less than or equal to 3 g/m², a basis weight of greater than or equal to 0.1 g/m² and less than or equal to 10 g/m², a basis weight of greater than or equal to 0.15 g/m² and less than or equal to 2 g/m², a basis weight of greater than or equal to 0.05 g/m² and less than or equal to 5 g/m², a basis weight of greater than or equal to 0.1 g/m² and less than or equal to 2 g/m²). Other values of basis weight are also possible. The basis weight may be determined according to the standard ISO 536 (2012).

In an exemplary set of embodiments, a hydraulic filtration component comprising a fine fiber layer as described herein may have a plurality of fibers having a basis weight as described above (e.g., a basis weight of greater than or equal to 0.05 g/m² and less than or equal to 30 g/m², a basis weight of greater than or equal to 0.5 g/m² and less than or equal to 3 g/m²). In another exemplary set of embodiments, a fuel filtration component comprising a fine fiber layer as described herein may have a plurality of fibers having a basis weight as described above (e.g., a basis weight of greater than or equal to 0.1 g/m² and less than or equal to 50 g/m², a basis weight of greater than or equal to 0.15 g/m² and less than or equal to 2 g/m²). In yet another exemplary set of embodiments, a HVAC or HEPA component comprising a fine fiber layer as described herein may have a plurality of fibers having a basis weight as described above (e.g., a basis weight of greater than or equal to 0.05 g/m² and less than or equal to 50 g/m², a basis weight of greater than or equal to 0.1 g/m² and less than or equal to 2 g/m²).

The fine fiber layer may have any suitable thickness. In some embodiments, the fine fiber layer may have a thickness of greater than or equal to 0.01 micron, greater than or equal to 0.1 micron, greater than or equal to 0.5 micron, greater than or equal to 1 micron, greater than or equal to 2 micron, greater than or equal to 5 micron, greater than or equal to 10 micron, greater than or equal to 100 micron, greater than or equal to 200 micron, greater than or equal to 500 micron, greater than or equal to 750 micron, greater than or equal to 1 mm, greater than or equal to 2 mm, greater than or equal to 5 mm, or greater than or equal to 10 mm. In some embodiments, the fine fiber layer may have a thickness of less than or equal to 10 mm, less than or equal to 5 mm, less than or equal to 2 mm, less than or equal to 1 mm, less than or equal to 750 micron, less than or equal to 500 micron, less than or equal to 200 micron, less than or equal to 100 micron, less than or equal to 10 micron, less than or equal to 5 micron, less than or equal to 2 micron, less than or equal to 1 micron, less than or equal to 0.5 micron, less than or equal to 0.1 micron, or less than or equal to 0.01 Combinations of the above-referenced ranges are also possible (e.g., greater than or equal to 0.01 micron and less than or equal to 10 mm, or greater than or equal to 0.1 micron and less than or equal to 5 mm). Other ranges are also possible. The thickness of the fine fiber layer or layers may be determined using Scanning Electron Microscopy. Briefly, a fine fiber layer cross-section may be coated with gold coating using sputter coater and mounted on the SEM. The thickness of fine fiber layer can be measured using ImageJ with an average of 5 measurements to determine the average thickness of fine fiber fine fiber layer.

In some embodiments, the fine fiber layer has a particular solidity. In some embodiments, the filter media may comprise one or more fine fiber layers, and the solidity of the fine fiber layer may be greater than or equal to 1, greater than or equal to 2, greater than or equal to 5, greater than or equal to 10, greater than or equal to 20, greater than or equal to 30, greater than or equal to 40, greater than or equal to 50, greater than or equal to 60, or greater than or equal to 70. In some embodiments, the solidity of the fine fiber layer may be less than or equal to 80, less than or equal to 70, less than or equal to 60, less than or equal to 50, less than or equal to 40, less than or equal to 30, less than or equal to 20, less than or equal to 10, less than or equal to 5, less than or equal to 2.5, or less than or equal to 2. Combinations of the above-referenced ranges are also possible (e.g., greater than or equal to 1 and less than or equal to 80, greater than or equal to 1 and less than or equal to 60). Other ranges are also possible. Solidity may be determined by using the following formula: solidity=[basis weight/(fiber density*thickness)]*100. The basis weight and thickness may be determined as described herein. The porosity can be derived from the solidity based on the following equation: solidity (%)=100−porosity (%). The fiber density is equivalent to the average density of the material or material(s) forming the fiber, which is typically specified by the fiber manufacturer. The average density of the materials forming the fibers may be determined by: (1) determining the total volume of all of the fibers in the fine fiber layer; and (2) dividing the total mass of all of the fibers in the fine fiber layer by the total volume of all of the fibers in the fine fiber layer. If the mass and density of each type of fiber in the fine fiber layer are known, the volume of all the fibers in the fine fiber layer may be determined by: (1) for each type of fiber, dividing the total mass of the type of fiber in the fine fiber layer by the density of the type of fiber; and (2) summing the volumes of each fiber type. If the mass and density of each type of fiber in the fine fiber layer are not known, the volume of all the fibers in the fine fiber layer may be determined in accordance with Archimedes' principle.

In embodiments for which the filter media comprises a fine fiber layer, the fine fiber layer may have any suitable dry tensile strength. In some embodiments, the dry tensile strength of the fine fiber layer is greater than or equal to 15 gf/gsm, greater than or equal to 20 gf/gsm, greater than or equal to 25 gf/gsm, greater than or equal to 30 gf/gsm, greater than or equal to 35 gf/gsm, greater than or equal to 40 gf/gsm, greater than or equal to 50 gf/gsm, greater than or equal to 60 gf/gsm, greater than or equal to 70 gf/gsm, greater than or equal to 80 gf/gsm, greater than or equal to 90 gf/gsm, greater than or equal to 100 gf/gsm, greater than or equal to 120 gf/gsm, greater than or equal to 150 gf/gsm, greater than or equal to 200 gf/gsm, or greater than or equal to 500 gf/gsm. In some embodiments, the dry tensile strength of the fine fiber layer is less than or equal to 750 gf/gsm, less than or equal to 500 gf/gsm, less than or equal to 200 gf/gsm, less than or equal to 150 gf/gsm, less than or equal to 120 gf/gsm, less than or equal to 100 gf/gsm, less than or equal to 90 gf/gsm, less than or equal to 80 gf/gsm, less than or equal to 70 gf/gsm, less than or equal to 60 gf/gsm, less than or equal to 50 gf/gsm, less than or equal to 40 gf/gsm, less than or equal to 35 gf/gsm, less than or equal to 30 gf/gsm, less than or equal to 25 gf/gsm, or less than or equal to 15 gf/gsm. Combinations of the above-referenced ranges are also possible (e.g., greater than or equal to 15 gf/gsm and less than or equal to 750 gf/gsm, or greater than or equal to 50 gf/gsm and less than or equal to 750 gf/gsm). Other ranges are also possible. Dry tensile strength, as described herein, may be determined by depositing fine fibers onto wax paper, to have a basis weight of 5 gsm. These freestanding fine fiber layers are then removed from the wax paper, with specimens cut to dimensions of 1 inch×7 inch for measurement on a Thwing-Albert tensile tester equipped with 20 N load cell. The gap between the jaws on the machine was 3.5 inches, and the rate of extension was 12 in/min. The tensile test data is then translated into stress-strain curves using Winwedge software. Average tensile strength is determined from at least 10 individual measurements and calculated from the stress-strain curves. Dry tensile strength is the average tensile strength normalized by dividing by the basis weight.

In certain embodiments, the fine fiber layer may have a dry tensile elongation at break of greater than or equal to 5%. For example, in some embodiments, the fine fiber layer may have a dry tensile elongation at break of greater than or equal to 5%, greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 100%, greater than or equal to 110%, greater than or equal to 120%, greater than equal to 130%, or greater than or equal to 140%. In certain embodiments, the fine fiber layer may have an elongation at break of less than or equal to 150%, less than or equal to 140%, less than or equal to 130%, less than or equal to 120%, less than or equal to 110%, less than or equal to 100%, less than or equal to 90%, less than or 80%, less than or equal to 70%, less than or equal to 60%, less than or equal to 50%, less than or equal to 40%, less than or equal to 30%, less than or equal to 20%, or less than or equal to 10%. Combinations of the above reference ranges are also possible (e.g., greater than or equal to 5% and less than or equal to 150%, greater than or equal to 10% and less than or equal to 60%). Other ranges are also possible.

The elongation at break may be determined by performing a tensile test, as described above. Briefly, the following procedure may be followed: (1) A 1″ by 7″ sample of the layer comprising the fine fibers may be cut from the layer comprising the fine fibers; (2) The 1″ by 7″ sample may be loaded into a Thwing-Albert tensile tester equipped with a 20 N load cell and having a gap between the jaws of 3.5″; (3) The sample may be extended by the jaws at a rate of 12″ per minute until the sample breaks.

A fine fiber layer as described herein may have a variety of suitable mean flow pore sizes. In some embodiments, a fine fiber layer has a mean flow pore size of greater than or equal to 0.05 micron, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 20 microns, or greater than or equal to 50 microns. In some embodiments, a fine fiber layer has a mean flow pore size of less than or equal to 75 microns, less than or equal to 50 microns, less than or equal to 25 microns, less than or equal to 20 microns, less than or equal to 10 microns, less than or equal to 8 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 microns or less than or equal to 0.05 microns. Combinations of the above-referenced ranges are also possible (e.g., greater than or equal to 0.0.05 micron and less than or equal to 75 microns, greater than or equal to 0.2 microns and less than or equal to 75 microns). Other ranges are also possible. The mean flow pore size of a fine fiber layer may be determined in accordance with ASTM F316 (2003).

A fine fiber layer may have a variety of suitable maximum pore sizes. In some embodiments, a fine fiber layer has a maximum pore size of greater than or equal to greater than or equal to 0.1 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 8 microns, greater than or equal to 10 microns, greater than or equal to 12.5 microns, greater than or equal to 25 microns, greater than or equal to 50 microns, greater than or equal to 75 microns, or greater than or equal to 90 microns. In some embodiments, a fine fiber layer has a maximum pore size of less than or equal to 100 microns, less than or equal to 75 microns, less than or equal to 50 microns, less than or equal to 25 microns, less than or equal to 15 microns, less than or equal to 12.5 microns, less than or equal to 10 microns, less than or equal to 8 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, or less than or equal to 0.75 microns. Combinations of the above-referenced ranges are also possible (e.g., greater than or equal to 0.1 microns and less than or equal to 100 microns, greater than or equal to 1 microns and less than or equal to 100 microns, or greater than or equal to 0.3 microns and less than or equal to 100 microns). Other ranges are also possible. The maximum pore size of a fine fiber layer may be determined in accordance with ASTM F316 (2003).

A fine fiber layer may have a variety of suitable water contact angles. In some embodiments, a fine fiber layer has a water contact angle of greater than or equal to 45°, greater than or equal to 50°, greater than or equal to 60°, greater than or equal to 70°, greater than or equal to 80°, greater than or equal to 90°, greater than or equal to 100°, greater than or equal to 110°, greater than or equal to 120°, greater than or equal to 135°, greater than or greater than or equal to 150°, or greater than or equal to 175°. In some embodiments, a fine fiber layer has a water contact angle of less than or equal to 180°, less than or equal to 175°, less than or equal to 150°, less than or equal to 135°, less than or equal to 120°, less than or equal to 110°, less than or equal to 100°, less than or equal to 90°, less than or equal to 80°, less than or equal to 70°, less than or equal to 60°, or less than or equal to 50°. Combinations of the above-referenced ranges are also possible (e.g., greater than or equal to 45° and less than or equal to 180°, greater than or equal to 50° and less than or equal to 135°, greater than or equal to 45° and less than or equal to 120°, or greater than or equal to 90° and less than or equal to 175°. Other ranges are also possible. The water contact angle of a fine fiber layer may be determined by in accordance with ASTM D5946 (2009). In some embodiments, the fine fiber layer is hydrophobic (i.e. having a water contact angle of greater than or equal to 90°)

In some embodiments, the fine fiber layer (or one or more layers of the filter media described herein) may be charged or uncharged. When present, charge (e.g., electrostatic charge) may be induced on the fine fiber layer (or other layer of the filter media) by a variety of suitable charging process, a non-limiting example of which includes corona discharging (e.g., employing AC corona, employing DC corona).

In some embodiments, the plurality of fibers comprising electrospun polyamide 11 fibers are piezoelectric. Without wishing to be bound by theory, the piezoelectric nature of electrospun polyamide 11 fibers may enhance the ability for the fibers to hold a charge (e.g., generated by corona discharging). For example, polyamide 11 may be relatively piezoelectric as compared to other polyamides like polyamide 6, polyamide 6,6, polyamide 6, 10, polyamide co-polymers (nylon 6, 66, 610), which are generally not piezoelectric. In some embodiments, such piezoelectric fibers may be poled to align the dipoles. Without wishing to be bound be theory, poled piezoelectric fibers (e.g., electrospun fibers such as electrospun fibers comprising polyamide 11) enable mechanical filtration technology combined with charge performance.

In some embodiments, the plurality of electrospun fibers (e.g., comprising polyamide 11) have a particular dielectric constant. In some embodiments, the dielectric constant of the electrospun fibers (e.g., comprising polyamide 11) is greater than or equal to 3, greater than or equal to 4, greater than or equal to 5, greater than or equal to 6, greater than or equal to 7, or greater than or equal to 8. In some embodiments, the dielectric constant of the electrospun fibers is less than or equal to 9, less than or equal to 8, less than or equal to 7, less than or equal to 6, less than or equal to 5, or less than or equal to 4. Combinations of the above referenced ranges are also possible (e.g., greater than or equal to 3 and less than or equal to 9, greater than or equal to 5 and less than or equal to 9). Other ranges are also possible. Advantageously, electrospun fibers comprising polyamide 11 have, in some embodiments, a higher dielectric constant as compared to fibers comprising other polyamides.

In certain embodiments, the plurality of fibers of the fine fiber layer may be designed to have a particular cross-sectional shape. In some embodiments, the cross-sectional shape of the plurality of fibers (e.g., a plurality of electrospun fibers, a plurality of fibers comprising polyamide 11) of the fine fiber layer is selected from the group consisting of round, cylindrical, elliptical, dogbone, kidney bean, ribbon, flat, and irregular.

As described herein, the plurality of fibers (e.g., plurality of fibers comprising polyamide 11) are formed using an electrospinning process (e.g., solvent electrospinning). The electrospinning process may be conducted at any suitable temperature. For example, in some embodiments, the electrospinning process is conducted at room temperature (e.g., a temperature greater than or equal to 20° C. and less than or equal to 25° C.).

Some fine fiber layers may be formed from a polymer solution. For instance, a fine fiber layer comprising electrospun fibers may be formed by electrospinning a polymer from the polymer solution onto a support layer to form an electrospun fine fiber layer disposed on the support layer. In some embodiments, the polymer solution comprises a precursor and one or more solvents (e.g., one or more solvents, two or more solvents, three or more solvents).

The precursor may be any material suitable for forming an electrospun fiber. For example, in some embodiments, the precursor comprises 11-aminoundecanoic acid. In some embodiments, the precursor comprises polyamide 11. In some embodiments, the precursor comprises a non-bio derived polyamide (e.g., polyamide 12, polyamide 6,10, polyamide 6,6, polyamide 6, copolymers thereof). In some embodiments, the polymer solution comprises a first precursor (e.g., for electrospinning polyamide 11) and a second precursor (e.g., for electrospinning a non-bio derived polyamide).

In an exemplary embodiment, a fine fiber layer comprising eletrospun fibers is formed by electrospinning a polyamide 11 polymer (and/or precursor) from the polymer solution onto a support layer to form the electrospun fine fiber layer disposed on the support layer.

In another exemplary embodiments, a fine fiber layer comprising electrospun fibers is formed by electrospinning a solution comprising polyamide 11 polymer and a non-bio derived polymer (e.g., polyamide 6) from the polymer solution onto a support layer to form the electrospun fine fiber layer (e.g., comprising a blend of electrospun polyamide fibers) disposed on the support layer.

Any suitable solvent for electrospinning polyamide 11 may be used. Non-limiting examples of suitable solvents include formic acid (FA), acetic acid (AA) trifluoroacetic acid (TFA), dichloromethane (DCM), and 1,1,1,3,3,3-Hexafluoro-2-propanol (HFP), and Pentafluoropentanoic acid (PFPA). Other solvents may also be possible.

The solvent may be present in the polymer solution in any suitable amount. For example, in some embodiments, the solvent is present in the polymer solution in an amount greater than or equal to 80 wt %, greater than or equal to 85 wt %, greater than or equal to 88 wt %, greater than or equal to 90 wt %, greater than or equal to 92 wt %, greater than or equal to 94 wt %, greater than or equal to 96 wt %, or greater than or equal to 98 wt % versus the total weight of the polymer solution. In some embodiments, the solvent is present in the polymer solution in an amount less than 100 wt %, less than or equal to 98 wt %, less than or equal to 96 wt %, less than or equal to 94 wt %, less than or equal to 92 wt %, less than or equal to 90 wt %, or less than or equal to 88 wt % versus the total weight of the polymer solution. Combinations of the above-referenced ranges are also possible (e.g., greater than or equal to 80 wt % and less than 100 wt %, greater than or equal to 88 wt % and less than or equal to 98 wt %, greater than or equal to 90 wt % and less than or equal to 98 wt %, greater than or equal to 94 wt % and less than or equal to 96 wt %). Other ranges are also possible.

In embodiments in which two or more solvents are present in the polymer solution, a first solvent and a second solvent may be present at any suitable ratio. For example, in some embodiments, a ratio of the first solvent to the second solvent present in the polymer solution is greater than or equal to 0:100, greater than or equal to 10:90, greater than or equal to 20:80, greater than or equal to 25:75, greater than or equal to 30:70, greater than or equal to 40:60, greater than or equal to 50:50, greater than or equal to 60:40, greater than or equal to 70:30, greater than or equal to 75:25, greater than or equal to 80:20, or greater than or equal to 90:10. In some embodiments, the ratio of the first solvent and the second solvent is less than or equal to 100:0, less than or equal to 90:10, less than or equal to 80:20, less than or equal to 75:25, less than or equal to 70:30, less than or equal to 60:40, less than or equal to 50:50, less than or equal to 40:60, less than or equal to 30:70, less than or equal to 25:75, less than or equal to 20:80, or less than or equal to 10:90. Combinations of the above-referenced ranges are also possible (e.g., greater than or equal to 0:100 and less than or equal to 100:0, greater than or equal to 10:90 and less than or equal to 25:75, greater than or equal to 90:10 and less than or equal to 75:25). Other ranges are also possible.

In an exemplary set of embodiments, the first solvent is formic acid and the second solvent is trifluoroacetic acid, and the ratio of the first solvent to the second solvent present in the polymer solution is greater than or equal to 0:100, greater than or equal to 10:90, greater than or equal to 20:80, greater than or equal to 25:75, greater than or equal to 30:70, greater than or equal to 40:60, greater than or equal to 50:50, greater than or equal to 60:40, greater than or equal to 70:30, greater than or equal to 75:25, greater than or equal to 80:20, or greater than or equal to 90:10. In another exemplary set of embodiments, the first solvent is formic acid and the second solvent is trifluoroacetic acid, and the ratio of the first solvent to the second solvent present in the polymer solution is less than or equal to 100:0, less than or equal to 90:10, less than or equal to 80:20, less than or equal to 75:25, less than or equal to 70:30, less than or equal to 60:40, less than or equal to 50:50, less than or equal to 40:60, less than or equal to 30:70, less than or equal to 25:75, less than or equal to 20:80, or less than or equal to 10:90. Combinations of the above-referenced ranges are also possible (e.g., greater than or equal to 0:100 and less than or equal to 100:0, greater than or equal to 10:90 and less than or equal to 25:75, greater than or equal to 90:10 and less than or equal to 75:25). Other ranges are also possible.

The polymer solution for forming the fine fiber layer may have a particular conductivity. In some embodiments, the conductivity of the polymer solution is greater than or equal to 300 μS, greater than or equal to 500 μS, greater than or equal to 1000 μS, greater than or equal to 2000 μS, greater than or equal to 3000 μS, greater than or equal to 4000 μS, greater than or equal to 5000 μS, greater than or equal to 6000 μS, greater than or equal to 7000 μS, greater than or equal to 8000 μS, greater than or equal to 9000 μS, greater than or equal to 10000 μS, or greater than or equal to 12500 μS. In some embodiments, the conductivity of the polymer solution is less than or equal to 15000 μS, less than or equal to 12500 μS, less than or equal to 10000 μS, less than or equal to 9000 μS, less than or equal to 8000 μS, less than or equal to 7000 μS, less than or equal to 6000 μS, less than or equal to 5000 μS, less than or equal to 4000 μS, less than or equal to 3000 μS, less than or equal to 2000 μS, less than or equal to 1000 μS, or less than or equal to 500 μS. Combinations of the above-referenced ranges are also possible (e.g., greater than or equal to 300 μS and less than or equal to 10000 μS, greater than or equal to 5000 μS and less than or equal to 9000 μS). Other ranges are also possible. The conductivity as described herein may be determined using a conductivity meter.

In some embodiments, the polymer solution has a viscosity of greater than or equal to 100 cPs, greater than or equal to 125 cPs, greater than or equal to 150 cPs, greater than or equal to 200 cPs, greater than or equal to 250 cPs, greater than or equal to 300 cPs, greater than or equal to 400 cPs, greater than or equal to 500 cPs, greater than or equal to 750 cPs, greater than or equal to 1000 cPs, or greater than or equal to 1250 cPs. In some embodiments, the polymer solution has a viscosity of less than or equal to 1500 cPs, less than or equal to 1250 cPs, less than or equal to 1000 cPs, less than or equal to 750 cPs, less than or equal to 500 cPs, less than or equal to 400 cPs, less than or equal to 300 cPs, less than or equal to 250 cPs, less than or equal to 200 cPs, less than or equal to 150 cPs, or less than or equal to 125 cPs. Combinations of the above-referenced ranges are also possible (e.g., greater than or equal to 100 cPs and less than or equal to 1500 cPs, or greater than or equal to 100 cPs and less than or equal to 1500 cPs, greater than or equal to 150 cPs and less than or equal to 400 cPs). Other ranges are also possible. The viscosity of the polymer solution may be determined by use of a rotational viscometer at a shear rate of 1.7 s⁻¹ and a temperature of 20° C. The viscosity may be determined from the rotational viscometer once the value displayed thereon has stabilized. One example of a suitable rotational viscometer is a Brookfield LVT viscometer having a No. 62 spindle.

In some embodiments, electrospinning may be conducted in an environment having a particular relative humidity. Without wishing to be bound by theory, the relative humidity of the electrospinning process may change fiber diameter and/or fiber formation. In some embodiments, electrospinning is conducted at a relative humidity of greater than or equal to 25%, greater than or equal to 30%, greater than or equal to 35%, greater than or equal to 40%, greater than or equal to 50% or greater than or equal to 60%. In some embodiments, electrospinning is conducted at a relative humidity of less than or equal to 65%, less than or equal to 50%, less than or equal to 45%, less than or equal to 40%, less than or equal to 35%, or less than or equal to 30%. Combinations of the above-referenced ranges are also possible (e.g., greater than or equal to 25% and less than or equal to 65%). Other ranges are also possible.

As described above, in some embodiments a filter media comprises a support layer. The support layer may support another layer present in the filter media (e.g., a fine fiber layer) and/or may be a layer onto which another layer was deposited during fabrication of the filter media. For example, in some embodiments, a filter media may comprise a support layer onto which a fine fiber layer was deposited (e.g., via electrospinning). The support layer may provide structural support and/or enhance the ease with which the filter media may be fabricated without appreciably increasing the resistance of the filter media. In some embodiments, the support layer does not contribute appreciably to the filtration performance of the filter media. In other embodiments, the support layer may enhance the performance of the filter media in one or more ways (e.g., it may serve as a prefilter layer). In some embodiments, a filter media comprises two or more support layers. For instance, a filter media may comprise two or more support layers disposed on one another that together form a composite support layer. In some embodiments, the fine fiber layer is disposed between two support layers (e.g., a first support layer and a second support layer). It should be understood that any individual support layer (and/or composite support layer) may independently have some or all of the properties described below with respect to support layers. It should also be understood that a filter media may comprise two support layers that are identical and/or may comprise two or more support layers that differ in one or more ways.

Support layers may comprise, for example, a non-woven web, woven media, a metal mesh, an elastic/polymer mesh (that may or may not be stretchable), a knitted fabric, and/or a scrim. When present, a support layer comprises, in an exemplary set of embodiments, a non-woven fiber web comprising a plurality of fibers. A variety of suitable types of non-woven fiber webs may be employed as support layers in the filter media described herein. For instance, a filter media may comprise a support layer comprising a wetlaid non-woven fiber web, a non-wetlaid non-woven fiber web (such as, e.g., a meltblown non-woven fiber web, a carded non-woven fiber web, a spunbond non-woven fiber web), an electrospun non-woven fiber web, and/or another type of non-woven fiber web. In embodiments in which more than one support layer is present, each support layer may independently be of one or more of the types described above.

When present, a support layer may comprise a plurality of fibers comprising a variety of suitable types of fibers. In some embodiments, a support layer comprises a plurality of fibers comprising natural fibers (e.g., hard wood fibers, soft wood fibers, cellulose fibers) and/or regenerated cellulose fibers. For example, cellulose fibers can be hardwood or soft wood fibers. Cellulose fibers can be other than natural cellulose fibers. As an example, the cellulose fibers may comprise regenerated and/or synthetic cellulose such asrayon, and celluloid. As another example, the cellulose fibers comprise natural cellulose derivatives, such as cellulose acetate and carboxymethylcellulose. The cellulose fibers, when present, may comprise fibrillated cellulose fibers, and/or may comprise un-fibrillated cellulose fibers.

In some embodiments, a support layer comprises a plurality of fibers comprising synthetic fibers. The synthetic fibers, if present, may include monocomponent synthetic fibers and/or multicomponent synthetic fibers (e.g., bicomponent synthetic fibers). Non-limiting examples of suitable synthetic fibers comprising a material selected from the group consisting of polypropylene, acrylics (dry-spun acrylic, mod-acrylic, wet-spun acrylic), polyvinyl chloride, polytetrafluoroethylene, polypropylene, polystyrene, polysulfone, polyethersulfone, polycarbonate, polyamide, polyurethane, phenolic, polyvinylidene fluoride, polyester, polyethylene, polyaramid (para and meta), polyimide, polyolefin, Kevlar, Nomex, halogenated polymers, polyacrylics, polyphenylene oxide, polyphenylene sulfide, polymethyl pentene, polyether ether ketones, PET, nylon, liquid crystal polymers (e.g., poly p-phenylene-2,6-bezobisoxazole (PBO), polyester-based liquid crystal polymers such as polyesters produced by the polycondensation of 4-hydroxybenzoic acid and 6-hydroxynaphthalene-2-carboxylic acid), and combinations thereof.

In some embodiments, a support layer comprises a plurality of fibers comprising glass fibers.

The support layer may include more than one type of fiber (e.g., both glass fibers and synthetic fibers) or may include exclusively one type of fiber (e.g., exclusively synthetic fibers of multiple sub-types, such as both polyolefin fibers and polyester fibers; or exclusively polypropylene fibers). In some embodiments, the plurality of fibers in the support layer comprises fibers comprising a blend of two or more of the polymers listed above (e.g., a blend of a Nylon and a polyester). In embodiments in which more than one support layer is present, each support layer may independently comprise fibers comprising one or more of the types of fibers described above.

When a support layer comprises a plurality of fibers comprising cellulose fibers, the cellulose fibers therein may have a variety of suitable average diameters. In some embodiments, a support layer comprises cellulose fibers having an average diameter of greater than or equal to 0.1 microns, greater than or equal to 0.5 microns, greater than or equal to 1 microns, greater than or equal to 2 microns, greater than or equal to 5 microns, greater than or equal to 7 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 60 microns, or greater than or equal to 70 microns. In some embodiments, a support layer comprises cellulose fibers having an average diameter of less than or equal to 75 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7 microns, less than or equal to 5 microns, less than or equal to 2 microns, less than or equal to 1 micron, or less than or equal to 0.5 microns. Combinations of the above-referenced ranges are also possible (e.g., greater than or equal to 0.1 microns and less than or equal to 75 microns, greater than or equal to 10 microns and less than or equal to 30 microns). Other ranges are also possible. In embodiments in which more than one support layer comprising cellulose fibers is present, each support layer comprising cellulose fibers may independently comprise cellulose fibers having an average diameter in one or more of the ranges described above.

When a support layer comprises a plurality of fibers comprising synthetic fibers, the synthetic fibers therein may have a variety of suitable average diameters. In some embodiments, a support layer comprises synthetic fibers having an average diameter of greater than or equal to 0.01 microns, greater than or equal to 0.02 microns, greater than or equal to 0.05 microns, greater than or equal to 0.075 microns, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 60 microns, greater than or equal to 70 microns, greater than or equal to 80 microns, or greater than or equal to 90 microns. In some embodiments, a support layer comprises synthetic fibers having an average diameter of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 10 microns and less than or equal to 60 microns, greater than or equal to 15 microns and less than or equal to 35 microns, greater than or equal to 0.01 microns and less than or equal to 100 microns, greater than or equal to 0.1 microns and less than or equal to 20 microns). Other ranges are also possible. In embodiments in which more than one support layer comprising synthetic fibers is present, each support layer comprising synthetic fibers may independently comprise synthetic fibers having an average diameter in one or more of the ranges described above.

When a support layer comprises a plurality of fibers comprising glass fibers, the glass fibers therein may have a variety of suitable average diameters. In some embodiments, a support layer comprises glass fibers having an average diameter of greater than or equal to 0.1 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, or greater than or equal to 35 microns. In some embodiments, a support layer comprises glass fibers having an average diameter of less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, or less than or equal to 0.2 microns. Combinations of the above-referenced ranges are also possible (e.g., greater than or equal to 0.1 microns and less than or equal to 40 microns, greater than or equal to 0.4 microns and less than or equal to 20 microns). Other ranges are also possible. In embodiments in which more than one support layer comprising glass fibers is present, each support layer comprising glass fibers may independently comprise glass fibers having an average diameter in one or more of the ranges described above.

In some embodiments, the plurality of fibers in a support layer, if present, may have a variety of suitable average lengths. In some embodiments, the average length of the fibers in a support layer is greater than or equal to 0.1 mm, greater than or equal to 0.3 mm, greater than or equal to 0.4 mm, greater than or equal to 0.5 mm, greater than or equal to 0.75 mm, greater than or equal to 1 mm, greater than or equal to 1.25 mm, greater than or equal to 1.5 mm, greater than or equal to 2 mm, greater than or equal to 3 mm, greater than or equal to 4 mm, greater than or equal to 5 mm, greater than or equal to 7.5 mm, greater than or equal to 10 mm, greater than or equal to 12.5 mm, greater than or equal to 15 mm, greater than or equal to 20 mm, greater than or equal to 25 mm, greater than or equal to 30 mm, greater than or equal to 40 mm, greater than or equal to 50 mm, greater than or equal to 75 mm, greater than or equal to 100 mm, greater than or equal to 150 mm, greater than or equal to 200 mm, or greater than or equal to 250 mm.

In some embodiments, the average length of the fibers in a support layer is less than or equal to 300 mm, less than or equal to 250 mm, less than or equal to 200 mm, less than or equal to 150 mm, less than or equal to 100 mm, less than or equal to 75 mm, less than or equal to 50 mm, less than or equal to 40 mm, less than or equal to 30 mm, less than or equal to 25 mm, less than or equal to 20 mm, less than or equal to 15 mm, less than or equal to 12.5 mm, less than or equal to 10 mm, less than or equal to 7.5 mm, less than or equal to 5 mm, less than or equal to 4 mm, less than or equal to 3 mm, less than or equal to 2.5 mm, less than or equal to 2 mm, less than or equal to 1.5 mm, less than or equal to 1.25 mm, less than or equal to 1 mm, less than or equal to 0.75 mm, less than or equal to 0.5 mm, or less than or equal to 0.4 mm. Combinations of the above-referenced ranges are also possible (e.g., greater than or equal to 0.1 mm and less than or equal to 300 mm, or greater than or equal to 0.1 mm and less than or equal to 25 mm, greater than or equal to 0.1 mm and less than or equal to 25 mm, greater than or equal to 1 mm and less than or equal to 10 mm). Other ranges are also possible. In embodiments in which more than one support layer is present, each support layer may independently comprise fibers having an average length in one or more of the ranges described above.

In some embodiments, the support layer comprises continuous fibers, which may have a variety of suitable lengths. For instance, the average length of the fibers in a support layer may be greater than or equal to 125 mm, greater than or equal to 150 mm, greater than or equal to 200 mm, greater than or equal to 250 mm, greater than or equal to 300 mm, greater than or equal to 400 mm, greater than or equal to 500 mm, greater than or equal to 750 mm, greater than or equal to 1 m, greater than or equal to 1.25 m, greater than or equal to 1.5 m, greater than or equal to 2 m, greater than or equal to 2.5 m, greater than or equal to 3 m, greater than or equal to 4 m, greater than or equal to 5 m, greater than or equal to 7.5 m, greater than or equal to 10 m, greater than or equal to 12.5 m, greater than or equal to 15 m, greater than or equal to 20 m, greater than or equal to 25 m, greater than or equal to 30 m, greater than or equal to 40 m, greater than or equal to 50 m, greater than or equal to 75 m, greater than or equal to 100 m, greater than or equal to 125 m, greater than or equal to 150 m, greater than or equal to 200 m, greater than or equal to 250 m, greater than or equal to 300 m, greater than or equal to 400 m, greater than or equal to 500 m, or greater than or equal to 750 m. In some embodiments, the average length of the fibers in a support layer is less than or equal to 1 km, less than or equal to 750 m, less than or equal to 500 m, less than or equal to 400 m, less than or equal to 300 m, less than or equal to 250 m, less than or equal to 200 m, less than or equal to 150 m, less than or equal to 125 m, less than or equal to 100 m, less than or equal to 75 m, less than or equal to 50 m, less than or equal to 40 m, less than or equal to 30 m, less than or equal to 25 m, less than or equal to 20 m, less than or equal to 15 m, less than or equal to 12.5 m, less than or equal to 10 m, less than or equal to 7.5 m, less than or equal to 5 m, less than or equal to 4 m, less than or equal to 3 m, less than or equal to 2.5 m, less than or equal to 2 m, less than or equal to 1.5 m, less than or equal to 1.25 m, less than or equal to 1 m, less than or equal to 750 mm, less than or equal to 500 mm, less than or equal to 400 mm, less than or equal to 300 mm, less than or equal to 250 mm, less than or equal to 200 mm, less than or equal to 150 mm, or less than or equal to 125 mm. Combinations of the above-referenced ranges are also possible (e.g., greater than or equal to 125 mm and less than or equal to 1 km, greater than or equal to 125 mm and less than or equal to 2 m). Other ranges are also possible. In embodiments in which more than one support layer is present, each support layer may independently comprise fibers having an average length in one or more of the ranges described above.

Synthetic fibers may be present in the support layer in any suitable amount. For example, in some embodiments, the synthetic fibers are present in the support layer in an amount greater than or equal to 0 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % versus the total weight of the support layer. In some embodiments, the synthetic fibers are present in the support layer in an amount less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, or less than or equal to 1 wt % versus the total weight of the support layer. Combinations of the above-referenced ranges are also possible (e.g., greater than or equal to 0 wt % and less than or equal to 100 wt %, greater than or equal to 1 wt % and less than or equal to 50 wt %, greater than or equal to 30 wt % and less than or equal to 80 wt %). Other ranges are also possible. In some embodiments, synthetic fibers may be present in the support layer in an amount of 100 wt % versus the total weight of the support layer.

Glass fibers may be present in the support layer in any suitable amount. For example, in some embodiments, the glass fibers are present in the support layer in an amount greater than or equal to 0 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % versus the total weight of the support layer. In some embodiments, the glass fibers are present in the support layer in an amount less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, or less than or equal to 1 wt % versus the total weight of the support layer. Combinations of the above-referenced ranges are also possible (e.g., greater than or equal to 0 wt % and less than or equal to 100 wt %, greater than or equal to 1 wt % and less than or equal to 50 wt %, greater than or equal to 10 wt % and less than or equal to 30 wt %). Other ranges are also possible. In some embodiments, glass fibers may be present in the support layer in an amount of 100 wt % versus the total weight of the support layer.

Cellulose fibers may be present in the support layer in any suitable amount. For example, in some embodiments, the cellulose fibers are present in the support layer in an amount greater than or equal to 0 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % versus the total weight of the support layer. In some embodiments, the cellulose fibers are present in the support layer in an amount less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, or less than or equal to 1 wt % versus the total weight of the support layer. Combinations of the above-referenced ranges are also possible (e.g., greater than or equal to 0 wt % and less than or equal to 100 wt %, greater than or equal to 1 wt % and less than or equal to 50 wt %, greater than or equal to 10 wt % and less than or equal to 30 wt %). Other ranges are also possible. In some embodiments, cellulose fibers may be present in the support layer in an amount of 100 wt % versus the total weight of the support layer.

Some support layers include components other than fibers. For instance, a support layer may comprise a binder resin. The binder resin may make up less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1.25 wt %, less than or equal to 1 wt %, less than or equal to 0.75 wt %, less than or equal to 0.5 wt %, less than or equal to 0.4 wt %, less than or equal to 0.3 wt %, less than or equal to 0.25 wt %, less than or equal to 0.2 wt %, less than or equal to 0.15 wt %, less than or equal to 0.125 wt %, or less than or equal to 0.1 wt % of the support layer. The binder resin may make up greater than or equal to 0 wt %, greater than or equal to 0.1 wt %, greater than or equal to 0.125 wt %, greater than or equal to 0.15 wt %, greater than or equal to 0.2 wt %, greater than or equal to 0.25 wt %, greater than or equal to 0.3 wt %, greater than or equal to 0.4 wt %, greater than or equal to 0.5 wt %, greater than or equal to 0.75 wt %, greater than or equal to 1 wt %, greater than or equal to 1.25 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, or greater than or equal to 80 wt % of the support layer. Combinations of the above-referenced ranges are also possible (e.g., less than or equal to 30 wt % of the support layer). Other ranges are also possible. In some embodiments, the support layer is binder-free (i.e., binder resin makes up 0 wt % of the support layer). In embodiments in which more than one support layer is present, each support layer may independently comprise a binder resin in an amount in one or more of the ranges described above.

In some embodiments, the binder resin comprises a polymer. Non-limiting examples of suitable polymers for use with a binder resin include styrene acrylate, styrene butyl acrylate, styrene butadiene, poly(methyl methacrylate), a copolymer of styrene and methyl methacrylate, a phenolic resin, acrylonitrile rubber, poly(ethylene), and poly(urethane).

In general, the cellulose fibers may include any suitable level of fibrillation (i.e., the extent of branching in the fiber). The level of fibrillation may be measured according to any number of suitable methods. For example, the level of fibrillation of the fibrillated fibers can be measured according to a Canadian Standard Freeness (CSF) test, specified by TAPPI test method T 227 om 09 Freeness of pulp. The test can provide an average CSF value.

In certain embodiments, the average CSF value of the cellulose fibers/regenerated cellulose fiber may be greater than or equal to 1 mL, greater than or equal to 10 mL, greater than or equal to 20 mL, greater than or equal to 35 mL, greater than or equal to 45 mL, greater than or equal to 50 mL, greater than or equal to 65 mL, greater than or equal to 70 mL, greater than or equal to 75 mL, greater than or equal to 80 mL, greater than or equal to 100 mL, greater than or equal to 110 mL, greater than or equal to 120 mL, greater than or equal to 130 mL, greater than or equal to 140 mL, greater than or equal to 150 mL, greater than or equal to 175 mL, greater than or equal to 200 mL, greater than or equal to 250 mL, greater than or equal to 300 mL, greater than or equal to 350 mL, greater than or equal to 400 mL, greater than or equal to 500 mL, greater than or equal to 600 mL, greater than or equal to 650 mL, greater than or equal to 700 mL, or greater than or equal to 750 mL. In some embodiments, the average CSF value of the cellulose fibers may be less than or equal to 800 mL, less than or equal to 750 mL, less than or equal to 700 mL, less than or equal to 650 mL, less than or equal to 600 mL, less than or equal to 550 mL, less than or equal to 500 mL, less than or equal to 450 mL, less than or equal to 400 mL, less than or equal to 350 mL, less than or equal to 300 mL, less than or equal to 250 mL, less than or equal to 225 mL, less than or equal to 200 mL, less than or equal to 150 mL, less than or equal to 140 mL, less than or equal to 130 mL, less than or equal to 120 mL, less than or equal to 110 mL, less than or equal to 100 mL, less than or equal to 90 mL, less than or equal to 85 mL, less than or equal to 70 mL, less than or equal to 50 mL, less than or equal to 40 mL, or less than or equal to 25 mL. Combinations of the above-referenced lower limits and upper limits are also possible (e.g., greater than or equal to 50 mL and less than or equal to 800 mL, greater than or equal to 120 mL and less than or equal to 500 mL). It should be understood that, in certain embodiments, the fibers may have fibrillation levels outside the above-noted ranges. The average CSF value of the cellulose fibers used in the layer(s) may be based on one type of cellulose fiber or more than one type cellulose fiber.

In general, a support layer may comprise multiple fibers having different average fiber diameters and/or fiber diameter distributions. In such cases, the average diameter of the fibers in a layer may be characterized using a weighted average, such as the surface average fiber diameter. The surface average fiber diameter is defined as

d=Σ(mᵢ/pᵢ)/Σ(mᵢ/dᵢpᵢ);

wherein d is the surface average fiber diameter in microns and is mᵢ the number fraction of the fibers with diameter dᵢ in microns and density Pᵢ in g/cm³ the filtration layer. The equation assumes that the fibers are cylindrical, the fibers have a circular cross-section, and that the fiber length is significantly greater than the diameter of the fibers. It should be understood that the equation also provides meaningful surface average fiber diameter values when a nonwoven web includes fibers that are substantially cylindrical and have a substantially circular cross-section.

As used herein, the density of a layer may be determined by accurately measuring the mass and volume of the layer (e.g., excluding the void volume) and then calculating the density of the layer. The mass of the layer may be determined by weighing the layer. The volume of the layer may be determined using any known method of accurately measuring volume. For example, the volume may be determined using pycnometry. As another example, the volume of the layer may be determined using an Archimedes method provided that an accurate measurement of volume is produced. For example, the volume may be determined by fully submerging the layer in a wetting fluid and measuring the volume displacement of the wetting liquid as a result of fully submerging the layer.

In some embodiments, the support layer may have a surface average fiber diameter of greater than or equal to 0.2 micron, greater than or equal to 0.5 micron, greater than or equal to 1 micron, greater than or equal to 2 microns, greater than or equal to 4 microns, greater than or equal to 6 microns, greater than or equal to 8 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 micron, greater than or equal to 17 microns, greater than or equal to 18 microns, greater than or equal to 19 microns, greater than or equal to 20 microns, greater than or equal to 25 microns, greater than or equal to 30 microns, or greater than or equal to 35 microns. In some instances, the surface average fiber diameter may be less than or equal to 40 microns, less than or equal to 35 microns, less than or equal to 30 microns, less than or equal to 25 microns, less than or equal to 20 microns, less than or equal to 19 microns, less than or equal to 18 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 10 microns, or less than or equal to 5 microns. Combinations of the above-referenced ranges are also possible (e.g., greater than or equal to 13 microns and less than or equal to 17 microns, greater than or equal to 14 microns and less than or equal to 16 microns, greater than or equal to 2 microns and less than or equal to 40 microns, greater than or equal to 0.2 micron and less than or equal to 25 microns, greater than or equal to 6 microns and less than or equal to 17 microns).

The thickness of the support layer may be selected as desired. For instance, in some embodiments, the filtration layer may have a thickness of greater than or equal to 0.05 mm, greater than or equal to 0.1 mm, greater than or equal to 0.2 mm, greater than or equal to 0.4 mm, greater than or equal to 0.5 mm, greater than or equal to 0.8 mm, greater than or equal to 1.0 mm, greater than or equal to 2.0 mm, greater than or equal to 3.0 mm, or greater than or equal to 4.0 mm. In some instances, the support layer may have a thickness of less than or equal to 5 mm, less than or equal to 2 mm, less than or equal to 1.2 mm, less than or equal to 1.0, less than or equal to 0.8 mm, less than or equal to 0.5 mm, less than or equal to 0.4 mm, or less than or equal to 0.2 mm. Combinations of the above-referenced ranges are also possible (e.g., a thickness of greater than or equal to 0.05 mm and less than or equal to 5.0 mm, or a thickness of greater than or equal to 0.1 mm and less than or equal to 1.0 mm). Other values of thickness are also possible. As determined herein, the thickness is measured according to the standard ISO 534 (2011) at 2 N/cm².

In some embodiments, a support layer may have a basis weight of less than or equal to 800 g/m², less than or equal to 600 g/m², less than or equal to 500 g/m², less than or equal to 400 g/m², less than or equal to 350 g/m², less than or equal to 300 g/m², less than or equal to 250 g/m², less than or equal to 200 g/m², less than or equal to 150 g/m², less than or equal to 120 g/m², less than or equal to 100 g/m², less than or equal to 75 g/m², less than or equal to 50 g/m², less than or equal to 40 g/m², less than or equal to about 30 g/m², less than or equal to 20 g/m², less than or equal to 10 g/m², less than or equal to 5 g/m² or less than or equal to 2 g/m². In some embodiments, the basis weight may be greater than or equal to 1 g/m², greater than or equal to 2 g/m², greater than or equal to 5 g/m², greater than or equal to 10 g/m², greater than or equal to 20 g/m², greater than or equal to 30 g/m², greater than or equal to 40 g/m², greater than or equal to 50 g/m², greater than or equal to 100 g/m², greater than or equal to 150 g/m², greater than or equal to 200 g/m², greater than or equal to 250 g/m², greater than or equal to 300 g/m², greater than or equal to 350 g/m², greater than or equal to 400 g/m², greater than or equal to 600 g/m², or greater than or equal to 750 g/m². Combinations of the above-referenced ranges are also possible (e.g., greater than or equal to 1 g/m² and less than or equal to 800 g/m², greater than or equal to 40 g/m² and less than or equal to 120 g/m²). Other values of basis weight are also possible. As determined herein, the basis weight of the support layer is measured according to the standard ISO 536 (2012).

A support layer as described herein may have a variety of suitable mean flow pore sizes. In some embodiments, a support layer has a mean flow pore size of greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 25 microns, greater than or equal to 50 microns, greater than or equal to 75 microns, greater than or equal to 100 microns, greater than or equal to 150 microns, greater than or equal to 200 microns, greater than or equal to 250 microns, greater than or equal to 500 microns or greater than or equal to 750 microns. In some embodiments, the support layer has a mean flow pore size of less than or equal to 1000 microns, less than or equal to 750 microns, less than or equal to 500 microns, less than or equal to 300 microns, less than or equal to 250 microns, less than or equal to 200 microns, less than or equal to 150 microns, less than or equal to 100 microns, less than or equal to 75 microns, less than or equal to 50 microns, less than or equal to 25 microns, less than or equal to 10 microns, less than or equal to 8 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, or less than or equal to 0.125 microns. Combinations of the above-referenced ranges are also possible (e.g., greater than or equal to 0.1 micron and less than or equal to 1000 microns, greater than or equal to 1 micron and less than or equal to 100 microns). Other ranges are also possible. The mean flow pore size of the support layer may be determined in accordance with ASTM F316 (2003).

The air permeability of a support layer described herein can vary. In some embodiments, the air permeability of the support layer may be, for example, greater than or equal to 0.5 ft³/min/ft² (CFM), greater than or equal to 1 CFM, greater than or equal to 2 CFM, greater than or equal to 5 CFM, greater than or equal to 10 CFM, greater than or equal to 15 CFM, greater than or equal to 25 CFM, greater than or equal to 50 CFM, greater than or equal to 100 CFM, greater than or equal to 150 CFM, greater than or equal to 200 CFM, greater than or equal to 250 CFM, greater than or equal to 300 CFM, greater than or equal to 350 CFM, greater than or equal to 400 CFM, greater than or equal to 500 CFM, greater than or equal to 600 CFM, greater than or equal to 700 CFM, greater than or equal to 1000 CFM. In some instances, the air permeability may be, for example, less than or equal to 1500 CFM, less than or equal to 1250 CFM, less than or equal to 1000 CFM, less than or equal to 800 CFM, less than or equal to 700 CFM, less than or equal to 600 CFM, less than or equal to 500 CFM, less than or equal to 400 CFM, less than or equal to 375 CFM, less than or equal to 350 CFM, less than or equal to 300 CFM, less than or equal to 250 CFM, less than or equal to 200 CFM, less than or equal to 150 CFM, less than or equal to 100 CFM, less than or equal to 50 CFM, less than or equal to 25 CFM, less than or equal to 20 CFM, less than or equal to 15 CFM, less than or equal to 10 CFM, less than or equal to 5 CFM, less than or equal to 2 CFM, or less than or equal to 1 CFM. Combinations of the above-referenced ranges are also possible (e.g., greater than or equal to 1 CFM and less than or equal to 1500, greater than or equal to 50 CFM and less than or equal to 500 CFM). The air permeability of the support layer may be determined in accordance with ASTM Test Standard D737-04 (2018) at a pressure of 125 Pa. The permeability of a support layer is an inverse function of flow resistance and can be measured with a Frazier Permeability Tester. The Frazier Permeability Tester measures the volume of air per unit of time that passes through a unit area of media at a fixed differential pressure across the media.

In embodiments for which the filter media comprises a support layer, the support layer (and/or the overall filter media) may have any suitable tensile strength. In some embodiments, the dry tensile strength of the support layer (and/or the overall filter media) is greater than or equal to 1 lb/in, greater than or equal to 2 lb/in, greater than or equal to 5 lb/in, greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 50 lb/in, greater than or equal to 60 lb/in, greater than or equal to 70 lb/in, greater than or equal to 80 lb/in, greater than or equal to 90 lb/in, greater than or equal to 100 lb/in, greater than or equal to 125 lb/in, greater than or equal to 150 lb/in, or greater than or equal to 175 lb/in. In some embodiments, the dry tensile strength of the support layer (and/or the overall filter media) is less than or equal to 200 lb/in, less than or equal to 175 lb/in, less than or equal to 150 lb/in, less than or equal to 125 lb/in, less than or equal to 120 lb/in, less than or equal to 100 lb/in, less than or equal to 90 lb/in, less than or equal to 80 lb/in, less than or equal to 70 lb/in, less than or equal to 60 lb/in, less than or equal to 50 lb/in, less than or equal to 40 lb/in, less than or equal to 35 lb/in, less than or equal to 30 lb/in, less than or equal to 25 lb/in, less than or equal to 20 lb/in, less than or equal to 15 lb/in, less than or equal to 10 lb/in, or less than or equal to 5 lb/in. Combinations of the above-referenced ranges are also possible (e.g., greater than or equal to 1 lb/in and less than or equal to 200 lb/in, or greater than or equal to 50 lb/in and less than or equal to 200 lb/in). Other ranges are also possible. The dry tensile strength may be determined according to the standard T494 om-96 using a test span of 4 in and a jaw separation speed of 1 in/min.

In some embodiments, the support layer (and/or the overall filter media) may have a dry Mullen Burst strength of greater than or equal to 0.5 psi, greater than or equal to 1 psi, greater than or equal to 2 psi, greater than or equal to 5 psi, greater than or equal to 10 psi, greater than or equal to 20 psi, greater than or equal to 25 psi, greater than or equal to 30 psi, greater than or equal to 50 psi, greater than or equal to 75 psi, greater than or equal to 100 psi, greater than or equal to 125 psi, greater than or equal to 150 psi, greater than or equal to 175 psi, greater than or equal to 200 psi, greater than or equal to 225 psi, or greater than or equal to 240 psi. In some instances, the dry Mullen Burst strength may be less than or equal to 250 psi, less than or equal to 240 psi, less than or equal to 225 psi, less than or equal to 200 psi, less than or equal to 175 psi, less than or equal to 150 psi, less than or equal to 125 psi, less than or equal to 100 psi, less than or equal to 75 psi, less than or equal to 50 psi, less than or equal to 25 psi, less than or equal to 20 psi, less than or equal to 10 psi, less than or equal to 5 psi, less than or equal to 2 psi, less than or equal to 1 psi, less than or equal to 0.5 psi. Combinations of the above-referenced ranges are also possible (e.g., greater than or equal to 0.5 psi and less than or equal to 250 psi, greater than or equal to 30 psi and less than or equal to 150 psi). Other values of dry Mullen Burst strength are also possible. The dry Mullen Burst strength may be determined according to the standard T403 om-91.

In some embodiments, the support layer (and/or the overall filter media) may have a Gurley stiffness of greater than or equal to about 1 mg, greater than or equal to about 2 mg, greater than or equal to about 5 mg, greater than or equal to about 10 mg, greater than or equal to about 50 mg, greater than or equal to about 100 mg, greater than or equal to about 200 mg, greater than or equal to about 300 mg, greater than or equal to about 500 mg, greater than or equal to about 800 mg, greater than or equal to about 1,000 mg, greater than or equal to about 1,200 mg, greater than or equal to about 1,400 mg, greater than or equal to 1,500 mg, greater than or equal to 2,000 mg, or greater than or equal to 3,000 mg. In some embodiments, the support layer (and/or the overall filter media) may have a Gurley stiffness of less than or equal to about 3,500 mg, less than or equal to about 3,000 mg, less than or equal to about 2,500 mg, less than or equal to about 2,000 mg, less than or equal to about 1,500 mg, less than or equal to about 1,400 mg, less than or equal to about 1,200 mg, less than or equal to about 1,000 mg, less than or equal to about 800 mg, less than or equal to about 500 mg, less than or equal to about 300 mg, less than or equal to about 200 mg, or less than or equal to about 100 mg. All suitable combinations of the above-referenced ranges are also possible (e.g., greater than or equal to about 1 mg and less than or equal to about 3,500 mg, greater than or equal to about 200 mg and less than or equal to about 1,000 mg). The stiffness may be determined using the Gurley stiffness (e.g., bending resistance) recorded in units of mm (equivalent to gu) in accordance with TAPPI T543 om-94.

The filter media comprising a fine fiber layer, support layer, and other additional layers, as described herein may have desirable properties such as overall pressure drop, overall air permeability, beta 200, and/or efficiency. For example, in some embodiments, the pressure drop across the entire filter media may be relatively low. For instance, in some embodiments, the pressure drop across the entire filter media may less than or equal to about 80 kPa, less than or equal to about 70 kPa, less than or equal to about 60 kPa, less than or equal to about 50 kPa, less than or equal to about 40 kPa, less than or equal to about 30 kPa, less than or equal to about 20 kPa, less than or equal to about 10 kPa, less than or equal to about 5 kPa, less than or equal to about 1 kPa, or less than or equal to about 0.5 kPa. In some instances, the entire filter media may have a pressure drop of greater than or equal to about 0.01 kPa, greater than or equal to about 0.02 kPa, greater than or equal to about 0.05 kPa, greater than or equal to about 0.1 kPa, greater than or equal to about 0.5 kPa, greater than or equal to 1 kPa, greater than or equal to about 5 kPa, greater than or equal to about 10 kPa, greater than or equal to about 20 kPa, greater than or equal to about 30 kPa, greater than or equal to about 40 kPa, greater than or equal to about 50 kPa, greater than or equal to about 60 kPa, or greater than or equal to about 70 kPa. Combinations of the above-referenced ranges are also possible (e.g., greater than or equal to about 0.05 kPa and less than or equal to about 80 kPa, greater than or equal to about 0.1 kPa and less than or equal to about 50 kPa, greater than or equal to about 0.05 kPa and less than or equal to about 50 kPa, greater than or equal to about 0.01 kPa and less than or equal to about 80 kPa). Other values of pressure drop are also possible. The pressure drop was measured using the ISO 3968 (2001) protocol. The pressure drop value was measured using a flat sheet of the layer(s) with hydraulic fluid at 15 cSt with a face velocity of 0.67 cm/s was passed through the filter media.

In some embodiments, the entire filter may exhibit an advantageous air permeability. In some embodiments, the entire filter media may have an air permeability of greater than or equal to 0.1 CFM, greater than or equal to 0.3 CFM, greater than or equal to 0.4 CFM, greater than or equal to 1 CFM, greater than or equal to 5 CFM, greater than or equal to 10 CFM, greater than or equal to 25 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, or greater than or equal to 275 CFM. In some instances, the entire filter media may have an air permeability of less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, or less than or equal to 25 CFM. Combinations of the above-referenced ranges are also possible (e.g., greater than or equal to 0.1 CFM and less than or equal to 300 CFM, greater than or equal to 1 CFM and less than or equal to 250 CFM, greater than or equal to 0.3 CFM and less than or equal to 300 CFM, greater than or equal to 0.3 CFM and less than or equal to 250 CFM). Other values of air permeability are also possible. The air permeability may be determined in accordance with ASTM Test Standard D737-04 (2018) at a fixed differential pressure of 125 Pa. The permeability of a filter media is generally an inverse function of flow resistance and can be measured with a Frazier Permeability Tester. The Frazier Permeability Tester measures the volume of air per unit of time that passes through a unit area of media at a fixed differential pressure across the media.

In some embodiments, a layer of the filter media (e.g., a first, second or third layer, such as a filtration layer), and/or the overall filter media may have a relatively low micron rating for beta efficiency (e.g., beta 200); that is, the minimum particle size for achieving a particular efficiency (e.g., a beta 200 efficiency or an efficiency of 99.5%) may be relatively low. For instance, in some instances, the micron rating for beta efficiency (e.g., beta 200) may be less than or equal to 30 microns, less than or equal to 28 microns, less than or equal to 25 microns, less than or equal to 24 microns, less than or equal to 22 microns, less than or equal to 20 microns, less than or equal to 18 microns, less than or equal to 16 microns, less than or equal to 14 microns, less than or equal to 12 microns, less than or equal to 10 microns, less than or equal to 8 microns, less than or equal to 5 microns, less than or equal to 4 microns, less than or equal to 3 microns, less than or equal to 2 microns, less than or equal to 1.5 microns, less than or equal to 1.0 microns, less than or equal to 0.5 microns, or less than or equal to 0.1 microns. In some embodiments, the micron rating for beta efficiency (e.g., beta 200) may be greater than or equal to 0 microns, greater than or equal to 0.1 microns, greater than or equal to 0.5 microns, greater than or equal to 1 microns, greater than or equal to 1.5 microns, greater than or equal to 2 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12 microns, greater than or equal to 15 microns, greater than or equal to 20 microns, or greater than or equal to 25 microns. Combinations of the above-referenced ranges are possible (e.g., greater than or equal to 0.1 microns and less than or equal to 30 microns, greater than or equal to 5 microns and less than or equal to 25 microns).

As used herein, the beta efficiency of a filter media is measured using a Multipass Filter Test following the ISO 16889 procedure (modified by testing a flat sheet sample), e.g., using a Multipass Filter Test Stand manufactured by FTI. The testing uses ISO 12103-1 A3 Medium test dust manufactured by PTI, Inc. at an upstream gravimetric dust level of 10 mg/liter. The test fluid is Aviation Hydraulic Fluid AERO HFA MIL H-5606A manufactured by Mobil. The test can be run at a face velocity of 0.67 cm/s until a terminal pressure of 500 kPa. Particle counts (particles per milliliter) at the particle sized selected (e.g., 1, 1.5, 2, 3, 4, 5, 7, 10, 15, 20, 25, or 30 microns) upstream and downstream of the media can be taken at ten points equally divided over the time of the test. The average of upstream and downstream particle counts can be taken at each selected particle size.

In some embodiments, a filter media, such as a filter media suitable for fuel filtration, has a relatively high average fuel-water separation efficiency. In some embodiments, a filter media has an average fuel-water separation efficiency of greater than or equal to 20%, greater than or equal to 25%, greater than or equal to 30%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, greater than or equal to 95%, greater than or equal to 98%, greater than or equal to 99%, or greater than or equal to 99.5%. In some embodiments, a filter media has an average fuel-water separation efficiency of less than or equal to 100%, less than or equal to 99.5%, less than or equal to 99%, less than or equal to 98%, less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 40%, less than or equal to 35%, less than or equal to 30%, or less than or equal to 25%. Combinations of the above-referenced ranges are also possible (e.g., greater than or equal to 20% and less than or equal to 99.9%, greater than or equal to 25% and less than or equal to 99.9%, or greater than or equal to 60% and less than or equal to 100%). Other ranges are also possible.

The average fuel-water separation efficiency of a filter media may be measured in accordance with the SAEJ1488 test. The test involves sending a sample of fuel (ultra-low sulfur diesel fuel) with controlled water content (2500 ppm) through a pump across the media at a face velocity of 0.069 cm/sec. The water is emulsified into fine droplets and sent to challenge the media. The water is coalesced, shed, or both coalesced and shed, and collects at the bottom of the housing. The water content of the sample is measured both upstream and downstream of the media, via Karl Fischer titration. The fuel-water separation efficiency is the amount of water removed from the fuel-water mixture, and is equivalent to (1−C/2500)*100%, where C is the downstream concentration of water. The average efficiency is the average of the efficiencies measured during a 150 minute test. The first measurement of the sample upstream and downstream of the media is taken at 10 minutes from the start of the test. Then, measurement of the sample downstream of the media is taken every 20 minutes until 150 minutes have elapsed from the beginning of the test.

In some embodiments, the filter media may have an overall fuel efficiency. As described herein, overall fuel efficiency can be measured according to standard ISO 19438 (2013). The testing uses ISO12103-A1 Fine grade test dust at a base upstream gravimetric dust level (BUGL) of 50 mg/liter. The test fluid is Aviation Hydraulic Fluid AERO HFA MIL H-5606A manufactured by Mobil. The test is run at a face velocity of 0.06 cm/s until a terminal pressure of 100 kPa. The average efficiency is the average of the efficiency values measured at one minute intervals until the terminal pressure is reached. A similar protocol can be used for measuring initial efficiency, which refers to the average efficiency measurements of the media at 4, 5, and 6 minutes after running the test. Unless otherwise indicated, average efficiency and initial efficiency measurements described herein refer to values where the particle size is 1.5 μm.

The filter media described herein may have a wide range of average fuel efficiencies. In some embodiments, a filter media has an average fuel efficiency of between 10% and 100%. The average fuel efficiency may be, for example, greater than or equal to 10%, greater than or equal to 20%, greater than or equal to 35%, greater than or equal to 50%, greater than or equal to 65%, greater than or equal to 80%, greater than or equal to 90%, greater than or equal to 95%, greater than or equal to 97%, greater than or equal to 99%, greater than or equal to 99.5%, greater than or equal to 99.8%, greater than or equal to 99.9%, or greater than or equal to 99.95%. The average fuel efficiency may be less than or equal to 99.99%, less than or equal to 99.95%, less than or equal to 99.9%, less than or equal to 99.8%, less than or equal to 99.5%, less than or equal to 99%, less than or equal to 97%, less than or equal to 95%, less than or equal to 90%, less than or equal to 80%, less than or equal to 65%, less than or equal to 50%, less than or equal to 35%, or less than or equal to 20%. Such average efficiencies may be achieved for filtering particles of different sizes such as particles of 10 μm or greater, particles of 8 μm or greater, particles of 6 μm or greater, particles of 5 μm or greater, particles of 4 μm or greater, particles of 3 μm or greater, particles of 2 μm or greater, particles of 1.5 μm or greater, or particles of 1 μm or greater. Other particle sizes and efficiencies are also possible. Combinations of above ranged particle sizes and average efficiencies are possible (e.g., an average efficiency of greater than or equal to 5% and less than or equal to 100% for filtering particles of 1.5 μm or greater).

In general, the filter media may have an advantageous overall mean flow pore size. For instance, in some embodiments, the filter media may have a mean flow pore size of greater than or equal to 0.05 μm, greater than or equal to 0.1 μm, greater than or equal to 0.2 μm, greater than or equal to 0.4 μm, greater than or equal to 0.5 μm, greater than or equal to 0.9 μm, greater than or equal to 1 μm, greater than or equal to 10 μm, greater than or equal to 25 μm, greater than or equal to 50 μm greater than or equal to 75 μm, greater than or equal to 100 μm. In some instances, the filter media may have a mean flow pore size of less than or equal to 200 μm, less than or equal to 150 μm, less than or equal to 125 μm, less than or equal to 100 μm, less than or equal to 75 μm, less than or equal to 50 μm, less than or equal to 25 μm, less than or equal to 10 μm or less than or equal to 1 μm. Combinations of the above-referenced ranges are also possible (e.g., greater than or equal to 0.05 μm and less than or equal to 200 μm, greater than or equal to 0.2 μm and less than or equal to 100 μm). Other values of mean flow pore size are also possible. The mean flow pore size may be determined according to the standard ASTM F316 (2003).

The dust holding capacity (DHC) of a filter media may vary. For example, a filter media can have an overall dust holding capacity of greater than or equal to 10 g/m², of greater than or equal to 20 g/m², greater than or equal to 30 g/m², greater than or equal to 40 g/m², greater than or equal to 50 g/m², greater than or equal to 80 g/m², greater than or equal to 100 g/m², greater than or equal to 125 g/m², greater than or equal to 150 g/m², greater than or equal to 160 g/m², greater than or equal to 180 g/m², greater than or equal to 200 g/m², greater than or equal to 220 g/m², greater than or equal to 240 g/m², greater than or equal to 260 g/m², or greater than or equal to 280 g/m². The dust holding capacity may be, for example, less than or equal to 500 g/m², less than or equal to 450 g/m², less than or equal to 400 g/m², less than or equal to 300 g/m², less than or equal to 280 g/m², less than or equal to 260 g/m², less than or equal to 240 g/m², less than or equal to 220 g/m², less than or equal to 200 g/m², less than or equal to 180 g/m², less than or equal to 160 g/m², less than or equal to 150 g/m², less than or equal to 125 g/m², less than or equal to 100 g/m², less than or equal to 80 g/m², less than or equal to 50 g/m², less than or equal to 40 g/m², less than or equal to 30 g/m², or less than or equal to 20 g/m². The dust holding capacity, as referred to herein, is tested based on a Multipass Filter Test following the ISO 19438 (2013) procedure, as described above. Unless otherwise stated, the dust holding capacity values described herein are determined at a terminal pressure of 100 kPa.

The filter media may have any suitable thickness. In some embodiments, the filter media may have a thickness of greater than or equal to greater than or equal to 0.01 mm, greater than or equal to 0.03 mm, greater than or equal to 0.05 mm, greater than or equal to 0.1 mm, greater than or equal to 0.2 mm, greater than or equal to 0.5 mm, greater than or equal to 1 mm, greater than or equal to 2 mm, greater than or equal to 3 mm, greater than or equal to 4 mm, greater than or equal to 5 mm, greater than or equal to 10 mm, greater than or equal to 20 mm, greater than or equal to 25 mm. In some embodiments, the filter media may have a thickness of less than or equal to 30 mm, less than or equal to 25 mm, less than or equal to 20 mm, less than or equal to 10 mm, less than or equal to 5 mm, less than or equal to 4 mm, less than or equal to 3 mm, less than or equal to 2 mm, less than or equal to 1 mm, less than or equal to 0.5 mm, less than or equal to 0.2 mm, less than or equal to 0.1 mm, or less than or equal to 0.05 mm. Combinations of the above-referenced ranges are also possible (e.g., greater than or equal to 0.03 mm and less than or equal to 30 mm, or greater than or equal to 0.05 mm and less than or equal to 20 mm). Other ranges are also possible. The thickness of the filter media or layers may be determined according to the standard ISO 534 (2011) at 2 N/cm².

In some embodiments, the filter media may have a basis weight of greater than or equal to 2 g/m², greater than or equal to 5 g/m², greater than or equal to 10 g/m², greater than or equal to 25 g/m², greater than or equal to 50 g/m², greater than or equal to 100 g/m², greater than or equal to 250 g/m², greater than or equal to 500 g/m², greater than or equal to 750 g/m², greater than or equal to 800 g/m², or greater than or equal to 900 g/m². In some embodiments, the filter media may have a basis weight of less than or equal to 1000 g/m², less than or equal to 900 g/m², less than or equal to 800 g/m², less than or equal to 750 g/m², less than or equal to 500 g/m², less than or equal to 250 g/m², less than or equal to 100 g/m², less than or equal to 50 g/m², less than or equal to 25 g/m², or less than or equal to 10 g/m². Combinations of the above-referenced ranges are also possible (e.g., a basis weight of greater than or equal to 2 g/m² and less than or equal to 1000 g/m², a basis weight of greater than or equal to 10 g/m² and less than or equal to 800 g/m²). Other values of basis weight are also possible. The basis weight may be determined according to the standard ISO 536.

In certain embodiments, the filter media, described herein, may have a particular surface area. For instance, in some embodiments, the filter media may have a surface area of greater than or equal to 0.01 m²/g, greater than or equal to 0.05 m²/g, greater than or equal to 0.1 m²/g, greater than or equal to 0.5 m²/g, greater than or equal to 1 m²/g, greater than or equal to 2 m²/g, greater than or equal to 5 m²/g, greater than or equal to 10 m²/g, greater than or equal to 25 m²/g, greater than or equal to 50 m²/g, greater than or equal to 75 m²/g, greater than or equal to 100 m²/g, greater than or equal to 200 m²/g, greater than or equal to 300 m²/g, or greater than or equal to 350 m²/g. In some embodiments, the surface area of the filter e-mail is less than or equal to 400 m²/g, less than or equal to 350 m²/g, less than or equal to 300 m²/g, less than or equal to 200 m²/g, less than or equal to 100 m²/g, less than or equal to 75 m²/g, less than or equal to 50 m²/g, less than or equal to 25 m²/g, less than or equal to 10 m²/g, less than or equal to 5 m²/g, less than or equal to 2 m²/g, less than or equal to 1 m²/g, less than or equal to 0.5 m²/g, less than or equal to 0.1 m²/g, or less than or equal to 0.05 m²/g. Combinations of the above-reference ranges are also possible (e.g., greater than or equal to 0.01 m²/g and less than or equal to 400 m²/g, greater than or equal to 0.1 m²/g and less than or equal to 3 m²/g). Other ranges area also possible. As determined herein, surface area of the filter media is measured through use of a standard BET surface area measurement technique. The BET surface area is measured according to section 10 of Battery Council International Standard BCIS-03A, “Recommended Battery Materials Specifications Valve Regulated Recombinant Batteries”, section 10 being “Standard Test Method for Surface Area of Recombinant Battery Separator Mat”. Following this technique, the BET surface area is measured via adsorption analysis using a BET surface analyzer (e.g., Micromeritics Gemini III 2375 Surface Area Analyzer) with nitrogen gas; the sample amount is between 0.5 and 0.6 grams in, e.g., a ¾″ tube; and, the sample is allowed to degas at 75 degrees C. for a minimum of 3 hours.

In some embodiments, the filter media may have an overall air permeability. In some embodiments, the overall air permeability of the filter media may be, for example, greater than or equal to 0.1 ft³/min/ft² (CFM), greater than or equal to 0.5 CFM, greater than or equal to 1 CFM, greater than or equal to 2 CFM, greater than or equal to 5 CFM, greater than or equal to 10 CFM, greater than or equal to 15 CFM, greater than or equal to 25 CFM, greater than or equal to 50 CFM, greater than or equal to 100 CFM, greater than or equal to 150 CFM, greater than or equal to 200 CFM, or greater than or equal to 250 CFM. In some instances, the air permeability may be, for example, less than or equal to 300 CFM, less than or equal to 250 CFM, less than or equal to 200 CFM, less than or equal to 150 CFM, less than or equal to 100 CFM, less than or equal to 50 CFM, less than or equal to 25 CFM, less than or equal to 20 CFM, less than or equal to 15 CFM, less than or equal to 10 CFM, less than or equal to 5 CFM, less than or equal to 2 CFM, or less than or equal to 1 CFM. Combinations of the above-referenced ranges are also possible (e.g., greater than or equal to 1 CFM and less than or equal to 300 CFM, greater than or equal to 1 CFM and less than or equal to 250 CFM). Other ranges are also possible. The overall air permeability of the filter media may be determined in accordance with ASTM Test Standard D737-04 (2018) at a fixed differential pressure of 125 Pa. The permeability of a filter media is generally an inverse function of flow resistance and can be measured with a Frazier Permeability Tester. The Frazier Permeability Tester measures the volume of air per unit of time that passes through a unit area of media at a fixed differential pressure across the media.

In some embodiments two or more layers of the filter media (e.g., fine fiber layer and support layer) may be formed separately and combined by any suitable method such as lamination, collation, or by use of adhesives. The two or more layers may be formed using different processes, or the same process. For example, each of the layers may be independently formed by an electrospinning process, a non-wet laid process (e.g., meltblown process, melt spinning process, centrifugal spinning process, electrospinning process, dry laid process, air laid process), a wet laid process, or any other suitable process.

Different layers may be adhered together by any suitable method. For instance, layers may be adhered by an adhesive and/or melt-bonded to one another on either side. Lamination and calendering processes may also be used. In some embodiments, an additional layer may be formed from any type of fiber or blend of fibers via an added headbox or a coater and appropriately adhered to another layer.

In some embodiments, a filter media comprises an adhesive positioned between two or more layers (e.g., between a fine fiber layer comprising a plurality of polyamide fibers and a second layer (e.g., a support layer, an additional layer)). As also described above, some filter media described herein comprise adhesive positioned between two or more pairs of layers (e.g., between a fine fiber layer and a second layer). It should be understood that an adhesive positioned between any specific pair of layers may have some or all of the properties described below with respect to adhesives. It should also be understood that a filter media may comprise two locations at which adhesive is positioned for which the adhesive has identical properties and/or may comprise two or more locations at which adhesive is positioned for which the adhesive differs in one or more ways.

In some embodiments, a filter media comprises an adhesive that is a solvent-based adhesive resin. As used herein, a solvent-based adhesive resin is an adhesive that is capable of undergoing a liquid to solid transition upon the evaporation of a solvent from the resin. Solvent-based adhesive resins may be applied while in the liquid state. Subsequently, the solvent that is present may evaporate to yield a solid adhesive. Solvent-based adhesives may thus be considered to be distinct from hot melt adhesives, which do not comprise volatile solvents (e.g., solvents that evaporate under normal operating conditions) and which typically undergo a liquid to solid transition as the adhesive cools.

In embodiments in which adhesive is present at more than one location, each location at which adhesive is present may independently comprise an adhesive that is a solvent-based adhesive resin.

Desirable properties for adhesives may include sufficient tackiness and open time (i.e., the amount of time that the adhesive remains tacky after being exposed to the ambient atmosphere). Without wishing to be bound by theory, the tackiness of an adhesive may depend on both the glass transition temperature of the adhesive and the molecular weight of any polymeric components of the adhesive. Higher values of glass transition and lower values of molecular weight may promote enhanced tackiness, and higher values of molecular weight may result in higher cohesion in the adhesive and higher bond strength. In some embodiments, adhesives having a glass transition temperature and/or molecular weight in one or more ranges described herein may provide appropriate values of both tackiness and open time. For example, the adhesive may be configured to remain tacky for a relatively long time (e.g., the adhesive may remain tacky after full evaporation of any solvents initially present, and/or may be tacky indefinitely when held at room temperature). In some embodiments, the open time of the adhesive may be less than or equal to 24 hours, less than or equal to 12 hours, less than or equal to 6 hours, less than or equal to 1 hour, less than or equal to 30 minutes, less than or equal to 15 minutes, less than or equal to 10 minutes, less than or equal to 5 minutes, less than or equal to 3 minutes, less than or equal to 1 minute, less than or equal to 30 seconds, or less than or equal to 10 seconds. In some embodiments, the open time of the adhesive may be at least 1 second, at least 10 seconds, at least 15 seconds, at least 30 seconds, at least 1 minute, at least 3 minutes, at least 5 minutes, at least 10 minutes, at least 15 minutes, at least 30 minutes, at least 1 hour, at least 6 hours, or at least 12 hours. Combinations of the above-referenced ranges are also possible (e.g., at least 1 second and less than or equal to 24 hours). Other values are also possible.

In embodiments in which adhesive is present at more than one location, each location at which adhesive is present may independently comprise an adhesive having an open time in one or more of the ranges described above.

Non-limiting examples of suitable adhesives include adhesives comprising acrylates, acrylate copolymers, poly(urethane)s, poly(ester)s, poly(vinyl alcohol), ethylene-vinyl acetate copolymers, silicone solvents, poly(olefin)s, synthetic and/or natural rubber, synthetic elastomers, ethylene-acrylic acid copolymers, ethylene-methacrylate copolymers, ethylene-methyl methacrylate copolymers, poly(vinylidene chloride), poly(amide)s, epoxies, melamine resins, poly(isobutylene), styrenic block copolymers, styrene-butadiene rubber, aliphatic urethane acrylates, and/or phenolics.

In embodiments in which adhesive is present at more than one location, each location at which adhesive is present may independently comprise an adhesive comprising one or more of the materials described above.

When present, an adhesive may comprise a crosslinker and/or may be crosslinked. In some embodiments, the crosslinker is a small molecule as described above and/or the crosslink is a reaction product of a small molecule crosslinker as described above. In some embodiments, an adhesive comprises a small molecule crosslinker (and/or a reaction product thereof) that is one or more of a carbodiimide, an isocyanate, an aziridine, a zirconium compound such as zirconium carbonate, a metal acid ester, a metal chelate, a multifunctional propylene imine, and an amino resin. In some embodiments, the adhesive comprises at least one polymer and/or prepolymer with one or more reactive functional groups that are capable of reacting with the crosslinker and/or comprises a reaction product of one or more reactive functional groups on a polymer and/or prepolymer that have reacted with the crosslinker. Non-limiting examples of suitable reactive functional groups include alcohol groups, carboxylic acid groups, epoxy groups, amine groups, and amino groups. In some embodiments, a filter media comprises an adhesive that comprises one or more polymers and/or prepolymers that may undergo self-crosslinking via functional groups attached thereto. In some embodiments, a filter media comprises an adhesive that comprises a self-crosslinked reaction product of one or more polymers and/or prepolymers.

In embodiments in which adhesive is present at more than one location, each location at which adhesive is present may independently comprise an adhesive comprising one or more of the materials described above.

When present, a small molecule crosslinker and/or crosslinks that are reaction products thereof may make up any suitable amount of an adhesive. In some embodiments, the wt % of the crosslinker and/or crosslinks that are reaction products thereof is greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 15 wt %, greater than or equal to 20 wt %, or greater than or equal to 25 wt % with respect to the total mass of the adhesive. In some embodiments, the wt % of the small molecule crosslinker and/or crosslinks that are reaction products thereof is less than or equal to 30 wt %, less than or equal to 25 wt %, less than or equal to 20 wt %, less than or equal to 15 wt %, less than or equal to 10 wt %, less than or equal to 5 wt %, less than or equal to 2 wt %, less than or equal to 1 wt %, less than or equal to 0.5 wt %, or less than or equal to 0.2 wt % with respect to the total mass of the adhesive. Combinations of the above-referenced ranges are also possible (e.g., greater than or equal to 0.1 wt % and less than or equal to 30 wt %, or greater than or equal to 1 wt % and less than or equal to 20 wt %). Other ranges are also possible.

In embodiments in which adhesive is present at more than one location, each location at which adhesive is present may independently comprise an adhesive comprising a small molecule crosslinker and/or crosslinks that are reaction products thereof in one or more of the amounts described above.

The adhesive and/or any small molecule crosslinkers therein may be capable of undergoing a crosslinking reaction at any suitable temperature and/or may have undergone a crosslinking reaction at any suitable temperature. In some embodiments, an adhesive may be capable of undergoing a cross-linking reaction and/or may have undergone a crosslinking reaction at a temperature of greater than or equal to 24° C., greater than or equal to 40° C., greater than or equal to 50° C., greater than or equal to 60° C., greater than or equal to 70° C., greater than or equal to 80° C., greater than or equal to 90° C., greater than or equal to 100° C., greater than or equal to 110° C., greater than or equal to 120° C., greater than or equal to 130° C., or greater than or equal to 140° C. In some embodiments, an adhesive may be capable of undergoing a cross-linking reaction and/or may have undergone a crosslinking reaction at a temperature of less than or equal to 150° C., less than or equal to 140° C., less than or equal to 130° C., less than or equal to 120° C., less than or equal to 110° C., less than or equal to 100° C., less than or equal to 90° C., less than or equal to 80° C., less than or equal to 70° C., less than or equal to 60° C., less than or equal to 50° C., or less than or equal to 40° C. Combinations of the above-referenced ranges are also possible (e.g., greater than or equal to 25° C. and less than or equal to 150° C., or greater than or equal to 25° C. and less than or equal to 130° C.). Other ranges are also possible.

In embodiments in which adhesive is present at more than one location, each location at which adhesive is present may independently comprise an adhesive capable of undergoing a crosslinking reaction and/or may have undergone a crosslinking reaction at a temperature in one or more of the ranges described above.

When present, an adhesive may comprise a solvent and/or may be formed from a composition comprising a solvent (e.g., from which the solvent has evaporated). By way of example, some embodiments relate to an adhesive applied to the layer or filter media while dissolved or suspended in a solvent. Non-limiting examples of suitable solvents include water, hydrocarbon solvents, ketones, aromatic solvents, fluorinated solvents, toluene, heptane, acetone, n-butyl acetate, methyl ethyl ketone, methylene chloride, naphtha, and mineral spirits.

In embodiments in which adhesive is present at more than one location, each location at which adhesive is present may independently comprise one or more of the solvents described above and/or may be formed from a composition comprising one or more of the solvents described above.

When present, an adhesive may have a relatively low glass transition temperature. In some embodiments, an adhesive has a glass transition temperature of less than or equal to 60° C., less than or equal to 50° C., less than or equal to 45° C., less than or equal to 40° C., less than or equal to 35° C., less than or equal to 30° C., less than or equal to 25° C., less than or equal to 24° C., less than or equal to 20° C., less than or equal to 15° C., less than or equal to 10° C., less than or equal to 5° C., less than or equal to 0° C., less than or equal to −5° C., less than or equal to −10° C., less than or equal to −20° C., less than or equal to −30° C., less than or equal to −40° C., less than or equal to −50° C., less than or equal to −60° C., less than or equal to −70° C., less than or equal to −80° C., less than or equal to −90° C., less than or equal to −100° C., or less than or equal to −110° C. In some embodiments, an adhesive has a glass transition temperature of greater than or equal to −125° C., greater than or equal to −110° C., greater than or equal to −100° C., greater than or equal to −90° C., greater than or equal to −80° C., greater than or equal to −70° C., greater than or equal to −60° C., greater than or equal to −50° C., greater than or equal to −40° C., greater than or equal to −30° C., greater than or equal to −20° C., greater than or equal to −10° C., greater than or equal to 0° C., greater than or equal to 5° C., greater than or equal to 10° C., greater than or equal to 24° C., greater than or equal to 25° C., greater than or equal to 40° C., or greater than or equal to 50° C. Combinations of the above-referenced ranges are also possible (e.g., greater than or equal to −125° C. and less than or equal to 60° C., or greater than or equal to −100° C. and less than or equal to 25° C.). Other ranges are also possible. The value of the glass transition temperature for an adhesive may be measured by differential scanning calorimetry.

In embodiments in which adhesive is present at more than one location, each location at which adhesive is present may independently comprise an adhesive having a glass transition temperature in one or more of the ranges described above.

When present, an adhesive may have a variety of suitable molecular weights. In some embodiments, an adhesive has a number average molecular weight of greater than or equal to 10 kDa, greater than or equal to 30 kDa, greater than or equal to 50 kDa, greater than or equal to 100 kDa, greater than or equal to 300 kDa, greater than or equal to 500 kDa, greater than or equal to 1000 kDa, greater than or equal to 2000 kDa, or greater than or equal to 3000 kDa. In some embodiments, an adhesive has a number average molecular weight of less than or equal to 5000 kDa, less than or equal to 4000 kDa, less than or equal to 3000 kDa, less than or equal to 1000 kDa, less than or equal to 500 kDa, less than or equal to 300 kDa, less than or equal to 100 kDa, less than or equal to 50 kDa, or less than or equal to 30 kDa. Combinations of the above-referenced ranges are also possible (e.g., greater than or equal to 10 kDa and less than or equal to 5000 kDa, or greater than or equal to 30 kDa and less than or equal to 3000 kDa). Other ranges are also possible. The number average molecular weight may be measured by light scattering.

In embodiments in which adhesive layer (e.g., comprising an adhesive) is present at more than one location, each location at which adhesive layer is present may independently comprise an adhesive having a molecular weight in one or more of the ranges described above.

When present, an adhesive layer may have a variety of suitable basis weights. In some embodiments, an adhesive has a basis weight of greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, an adhesive layer has a basis weight of less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible.

In embodiments in which adhesive is present at more than one location, each location at which adhesive is present may independently comprise an adhesive having a basis weight in one or more of the ranges described above.

In embodiments where the filter media comprises one or more adhesives, the total basis weight of the adhesives in the filter media together (i.e., the sum of the basis weights of the adhesive at each location) may be greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, the total basis weight of the adhesives in the filter media together may be less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible.

When present, an adhesive may adhere together two or more layers between which it is positioned. The strength of adhesion between the two layers may be relatively high. For instance, an adhesive may adhere two layers together with a bond strength of greater than or equal to 100 g/in², greater than or equal to 150 g/in², greater than or equal to 200 g/in², greater than or equal to 500 g/in², greater than or equal to 750 g/in², greater than or equal to 1000 g/in², greater than or equal to 1250 g/in², greater than or equal to 1500 g/in², greater than or equal to 1750 g/in², greater than or equal to 2000 g/in², greater than or equal to 2250 g/in², greater than or equal to 2500 g/in², greater than or equal to 2750 g/in², greater than or equal to 3000 g/in², greater than or equal to 3250 g/in², greater than or equal to 3500 g/in², greater than or equal to 3750 g/in², greater than or equal to 4000 g/in², greater than or equal to 4250 g/in², greater than or equal to 4500 g/in², or greater than or equal to 4750 g/in². In some embodiments, an adhesive adheres two layers together with a bond strength of less than or equal to 5000 g/in², less than or equal to 4750 g/in², less than or equal to 4500 g/in², less than or equal to 4250 g/in², less than or equal to 4000 g/in², less than or equal to 3750 g/in², less than or equal to 3500 g/in², less than or equal to 3250 g/in², less than or equal to 3000 g/in², less than or equal to 2750 g/in², less than or equal to 2500 g/in², less than or equal to 2250 g/in², less than or equal to 2000 g/in², less than or equal to 1750 g/in², less than or equal to 1500 g/in², less than or equal to 1250 g/in², less than or equal to 1000 g/in², less than or equal to 750 g/in², less than or equal to 500 g/in², less than or equal to 200 g/in², or less than or equal to 150 g/in². Combinations of the above-referenced ranges are also possible (e.g., greater than or equal to 100 g/in² and less than or equal to 5000 g/in², or greater than or equal to 150 g/in² and less than or equal to 3000 g/in²). Other ranges are also possible.

In embodiments in which adhesive is present at more than one location, each location at which adhesive is present may independently comprise an adhesive adhering together two layers with a bond strength in one or more of the ranges described above. In some embodiments, the entire filter media as a whole has an internal bond strength in one or more ranges described above. The bond strength of the entire filter media as a whole is equivalent to the weakest bond strength between two layers of the media.

The bond strength (e.g., internal bond strength) between two layers (e.g., between two layers adhered together by an adhesive) may be determined by using a z-directional peel strength test. In short, the bond strength may be determined by the following procedure. First, a 1″×1″ sample may be mounted on a steel block with dimensions 1″×1″×0.5″ using double sided tape. The sample block may then be mounted onto the non-traversing head of a tensile tester and another steel block of the same size may be connected to the traversing head with double sided tape. The traversing head may brought down and bonded to the sample on the steel block of the non-traversing head. Enough pressure may be applied so that the steel blocks are bonded together via the mounted sample. The traversing head may then be moved at a traversing speed of 1″/min and the maximum load is found from the peak of a stress-strain curve. The bond strength (e.g., internal bond strength) between the two layers is considered to be equivalent to the maximum load measured by this procedure.

In some embodiments, further processing may involve pleating the filter media. For instance, two layers may be joined by a co-pleating process. In some cases, the filter media, or various layers thereof, may be suitably pleated by forming score lines at appropriately spaced distances apart from one another, allowing the filter media to be folded. In some cases, one layer can be wrapped around a pleated layer. It should be appreciated that any suitable pleating technique may be used.

In some embodiments, a filter media can be post-processed such as subjected to a corrugation process to increase surface area within the web. In other embodiments, a filter media may be embossed.

The filter media may include any suitable number of layers, e.g., one layer, at least 2, at least 3, at least 4, at least 5, at least 6, at least 7 layers. In some embodiments, the filter media may include up to 20 layers.

Filter media described herein may be used in an overall filtration arrangement or filter element. In some embodiments, one or more additional layers or components are included with the filter media. For example, as shown illustratively in FIG. 1B, filter media 102 comprises a fine fiber layer 110, a support layer 120, and an additional layer 130 adjacent the fine fiber layer. While FIG. 1B depicts additional layer adjacent fine fiber layer 110, those of ordinary skill in the art would understand, based upon the teachings of this specification, that the filter media are not limited as such. For example, in some embodiments, each additional layer may be adjacent (e.g., directly adjacent) the fine fiber layer, the support layer, or disposed between the fine fiber layer and the support layer.

Non-limiting examples of additional layers (e.g., a third layer, a fourth layer) include a meltblown layer, a wet laid layer, a spunbond layer, a carded layer, an air-laid layer, a spunlace layer, a forcespun layer, an electrospun layer, or a mesh layer (e.g., an elastic mesh, a metal mesh, a non-elastic mesh). In some embodiments, the additional layer may be a woven layer or a non-woven layer. The additional layers may comprise a plurality of fibers as described herein in the context of a support layer and/or a fine fiber layer (e.g., electrospun fibers, glass fibers, cellulose fibers, synthetic fibers, etc.).

In some embodiments, the additional layer, if present, may have a surface average fiber diameter of greater than or equal to 0.2 micron, greater than or equal to 0.5 micron, greater than or equal to 1 micron, greater than or equal to 2 microns, greater than or equal to 4 microns, greater than or equal to 6 microns, greater than or equal to 8 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 micron, greater than or equal to 17 microns, greater than or equal to 18 microns, greater than or equal to 19 microns, greater than or equal to 20 microns, greater than or equal to 25 microns, greater than or equal to 30 microns, or greater than or equal to 35 microns. In some instances, the surface average fiber diameter may be less than or equal to 40 microns, less than or equal to 35 microns, less than or equal to 30 microns, less than or equal to 25 microns, less than or equal to 20 microns, less than or equal to 19 microns, less than or equal to 18 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 10 microns, or less than or equal to 5 microns. Combinations of the above-referenced ranges are also possible (e.g., greater than or equal to 13 microns and less than or equal to 17 microns, greater than or equal to 14 microns and less than or equal to 16 microns, greater than or equal to 2 microns and less than or equal to 40 microns, greater than or equal to 0.2 micron and less than or equal to 25 microns, greater than or equal to 6 microns and less than or equal to 17 microns).

The thickness of the additional layer, if present, may be selected as desired. For instance, in some embodiments, the filtration layer may have a thickness of greater than or equal to 0.05 mm, greater than or equal to 0.1 mm, greater than or equal to 0.2 mm, greater than or equal to 0.4 mm, greater than or equal to 0.5 mm, greater than or equal to 0.8 mm, greater than or equal to 1.0 mm, greater than or equal to 2.0 mm, greater than or equal to 3.0 mm, or greater than or equal to 4.0 mm. In some instances, the additional layer, if present, may have a thickness of less than or equal to 5 mm, less than or equal to 2 mm, less than or equal to 1.2 mm, less than or equal to 1.0, less than or equal to 0.8 mm, less than or equal to 0.5 mm, less than or equal to 0.4 mm, or less than or equal to 0.2 mm. Combinations of the above-referenced ranges are also possible (e.g., a thickness of greater than or equal to 0.05 mm and less than or equal to 5.0 mm, or a thickness of greater than or equal to 0.1 mm and less than or equal to 1.0 mm). Other values of thickness are also possible. As determined herein, the thickness is measured according to the standard ISO 534 (2011) at 2 N/cm².

In some embodiments, an additional layer, if present, may have a basis weight of less than or equal to 800 g/m², less than or equal to 600 g/m², less than or equal to 500 g/m², less than or equal to 400 g/m², less than or equal to 350 g/m², less than or equal to 300 g/m², less than or equal to 250 g/m², less than or equal to 200 g/m², less than or equal to 150 g/m², less than or equal to 120 g/m², less than or equal to 100 g/m², less than or equal to 75 g/m², less than or equal to 50 g/m², less than or equal to 40 g/m², less than or equal to about30 g/m², less than or equal to 20 g/m², less than or equal to 10 g/m², less than or equal to 5 g/m² or less than or equal to 2 g/m². In some embodiments, the basis weight may be greater than or equal to 1 g/m², greater than or equal to 2 g/m², greater than or equal to 5 g/m², greater than or equal to 10 g/m², greater than or equal to 20 g/m², greater than or equal to 30 g/m², greater than or equal to 40 g/m², greater than or equal to 50 g/m², greater than or equal to 100 g/m², greater than or equal to 150 g/m², greater than or equal to 200 g/m², greater than or equal to 250 g/m², greater than or equal to 300 g/m², greater than or equal to 350 g/m², greater than or equal to 400 g/m², greater than or equal to 600 g/m², or greater than or equal to 750 g/m². Combinations of the above-referenced ranges are also possible (e.g., greater than or equal to 1 g/m² and less than or equal to 800 g/m², greater than or equal to 40 g/m² and less than or equal to 120 g/m²). Other values of basis weight are also possible. As determined herein, the basis weight of the additional layer, if present, is measured according to the standard ISO 536 (2012).

An additional layer, if present, as described herein may have a variety of suitable mean flow pore sizes. In some embodiments, an additional layer, if present, has a mean flow pore size of greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 25 microns, greater than or equal to 50 microns, greater than or equal to 75 microns, greater than or equal to 100 microns, greater than or equal to 150 microns, greater than or equal to 200 microns, greater than or equal to 250 microns, greater than or equal to 500 microns or greater than or equal to 750 microns. In some embodiments, the additional layer, if present, has a mean flow pore size of less than or equal to 1000 microns, less than or equal to 750 microns, less than or equal to 500 microns, less than or equal to 300 microns, less than or equal to 250 microns, less than or equal to 200 microns, less than or equal to 150 microns, less than or equal to 100 microns, less than or equal to 75 microns, less than or equal to 50 microns, less than or equal to 25 microns, less than or equal to 10 microns, less than or equal to 8 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, or less than or equal to 0.125 microns. Combinations of the above-referenced ranges are also possible (e.g., greater than or equal to 0.1 micron and less than or equal to 1000 microns, greater than or equal to 1 micron and less than or equal to 100 microns). Other ranges are also possible. The mean flow pore size of the additional layer, if present, may be determined in accordance with ASTM F316 (2003).

The air permeability of an additional layer, if present, described herein can vary. In some embodiments, the air permeability of the additional layer, if present, may be, for example, greater than or equal to 0.5 ft³/min/ft² (CFM), greater than or equal to 1 CFM, greater than or equal to 2 CFM, greater than or equal to 5 CFM, greater than or equal to 10 CFM, greater than or equal to 15 CFM, greater than or equal to 25 CFM, greater than or equal to 50 CFM, greater than or equal to 100 CFM, greater than or equal to 150 CFM, greater than or equal to 200 CFM, greater than or equal to 250 CFM, greater than or equal to 300 CFM, greater than or equal to 350 CFM, greater than or equal to 400 CFM, greater than or equal to 500 CFM, greater than or equal to 600 CFM, greater than or equal to 700 CFM, greater than or equal to 1000 CFM. In some instances, the air permeability may be, for example, less than or equal to 1500 CFM, less than or equal to 1250 CFM, less than or equal to 1000 CFM, less than or equal to 800 CFM, less than or equal to 700 CFM, less than or equal to 600 CFM, less than or equal to 500 CFM, less than or equal to 400 CFM, less than or equal to 375 CFM, less than or equal to 350 CFM, less than or equal to 300 CFM, less than or equal to 250 CFM, less than or equal to 200 CFM, less than or equal to 150 CFM, less than or equal to 100 CFM, less than or equal to 50 CFM, less than or equal to 25 CFM, less than or equal to 20 CFM, less than or equal to 15 CFM, less than or equal to 10 CFM, less than or equal to 5 CFM, less than or equal to 2 CFM, or less than or equal to 1 CFM. Combinations of the above-referenced ranges are also possible (e.g., greater than or equal to 1 CFM and less than or equal to 1500, greater than or equal to 50 CFM and less than or equal to 500 CFM). The air permeability of the additional layer, if present, may be determined in accordance with ASTM Test Standard D737-04 (2018) at a pressure of 125 Pa. The permeability of an additional layer, if present, is an inverse function of flow resistance and can be measured with a Frazier Permeability Tester. The Frazier Permeability Tester measures the volume of air per unit of time that passes through a unit area of media at a fixed differential pressure across the media.

It should be appreciated that the filter media may include other parts in addition to the one or more layers described herein. In some embodiments, further processing includes incorporation of one or more structural features and/or stiffening elements. For instance, the filter media may be combined with additional structural features such as polymeric and/or metallic meshes. In one embodiment, a screen backing may be disposed on the filter media, providing for further Gurley stiffness. In some cases, a screen backing may aid in retaining the pleated configuration. For example, a screen backing may be an expanded metal wire or an extruded plastic mesh.

In some embodiments, an additional layer described herein may be a nonwoven web. A nonwoven web may include non-oriented fibers (e.g., a random arrangement of fibers within the web). Examples of nonwoven webs include webs made by wet-laid or non-wet laid processes as described herein.

The filter media may be incorporated into a variety of suitable filter elements for use in various applications including gas and liquid filtration.

The filter media can be incorporated into a variety of filter elements for use in hydraulic filtration applications and/or fuel filtration applications. Exemplary uses of hydraulic filters (e.g., high-, medium-, and low-pressure specialty filters) include mobile and industrial filters, biopharma filters, bioprocess filters, and filters for liquid and/or water filtration. Filter media suitable for gas filtration may be used for HVAC, HEPA, face mask, and ULPA filtration applications. For example, the filter media may be used in heating and air conditioning ducts. In another example, the filter media may be used for respirator and face mask applications (e.g., surgical face masks, industrial face masks, and industrial respirators).

Filter elements may have any suitable configuration as known in the art including bag filters and panel filters. Filter assemblies for filtration applications can include any of a variety of filter media and/or filter elements. The filter elements can include the above-described filter media. Examples of filter elements include fuel filter elements, hydraulic filter elements, oil filter elements (e.g., lube oil filter elements or heavy duty lube oil filter elements), gas turbine filter elements, dust collector elements, heavy duty air filter elements, automotive air filter elements, air filter elements for large displacement gasoline engines (e.g., SUVs, pickup trucks, trucks), HVAC air filter elements, HEPA filter elements, ULPA filter elements, and vacuum bag filter elements.

Filter elements can be incorporated into corresponding filter systems (gas turbine filter systems, heavy duty air filter systems, automotive air filter systems, HVAC air filter systems, HEPA filter systems, ULPA filter system, vacuum bag filter systems, fuel filter systems, and oil filter systems). The filter media can optionally be pleated into any of a variety of configurations (e.g., panel, cylindrical).

Filter elements can also be in any suitable form, such as radial filter elements, panel filter elements, or channel flow elements. A radial filter element can include pleated filter media that are constrained within two open wire meshes in a cylindrical shape. During use, fluids can flow from the outside through the pleated media to the inside of the radial element.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

As noted above, in some embodiments, the filter media can be incorporated into a bag (or pocket) filter element. A bag filter element may be formed by any suitable method, e.g., by placing two filter media together (or folding a single filter media in half), and mating three sides (or two if folded) to one another such that only one side remains open, thereby forming a pocket inside the filter. In some embodiments, multiple filter pockets may be attached to a frame to form a filter element. It should be understood that the filter media and filter elements may have a variety of different constructions and the particular construction depends on the application in which the filter media and elements are used. In some cases, a substrate may be added to the filter media.

The filter elements may have the same property values as those noted above in connection with the filter media. For example, the above-noted pressure drop, thicknesses, and/or basis weight may also be found in filter elements.

In an exemplary set of embodiments, the filter media may be used in a hydraulic application and comprises a fine fiber layer adjacent (e.g., comprising a plurality of electrospun fibers and/or polyamide 11 fibers) a support layer (e.g., a spunbond layer). In some embodiments, a third layer (e.g., comprising a meltblown layer, a scrim layer) is disposed on the fine fiber layer. In some embodiments, a fourth layer (e.g., a prefilter layer comprising a plurality of glass fibers, a prefilter layer comprising a plurality of synthetic fibers) is disposed on the third layer, if present, or on the fine fiber layer. In some embodiments, the fourth layer may comprise a single or multiple layers.

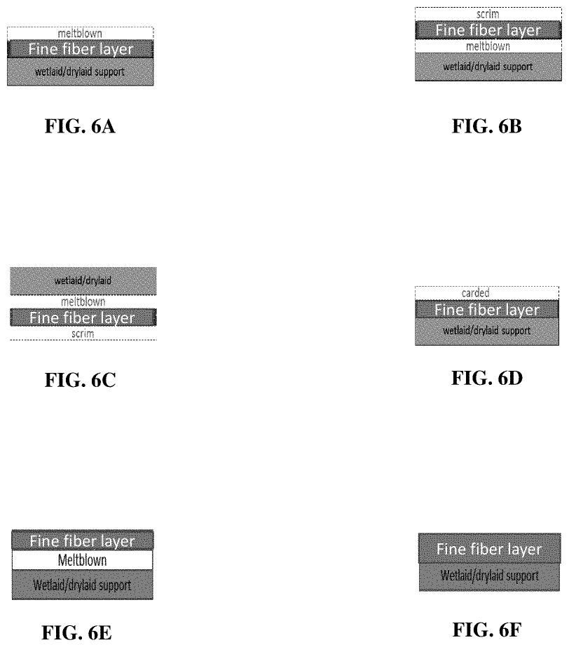

For example, FIGS. 6A-6F show exemplary configurations of filter media comprising a fine fiber layer (e.g., comprising polyamide 11 fibers, electrospun fibers) and a support layer adjacent the fine fiber layer (e.g., a wetlaid and/or drylaid support) and, in some configurations, optionally one or more additional layers (e.g., a meltblown layer, a scrim, a carded layer). Such configurations may be useful in, for example, hydraulic applications.

In another exemplary set of embodiments, the filter media may be used in a fuel application and comprises a support layer (e.g., comprising a wetlaid and/or drylaid layer), a fine fiber layer (e.g., comprising a plurality of electrospun fibers and/or polyamide 11 fibers) adjacent the support layer, and a third layer (e.g., a meltblown layer). In some embodiments, the third layer is disposed between the fine fiber layer and the support layer. In some embodiments, the fine fiber layer is directly adjacent the support layer and the third layer is disposed on the fine fiber layer. In some embodiments, the third layer is not present.

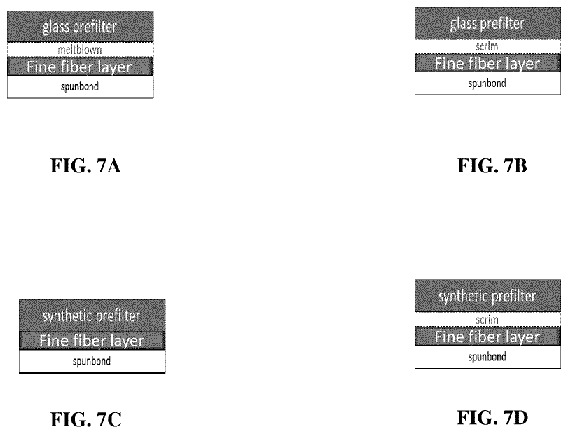

For example, FIGS. 7A-7D show exemplary configurations of filter media comprising a fine fiber layer (e.g., comprising polyamide 11 fibers, electrospun fibers) and a support layer adjacent the fine fiber layer (e.g., a spunbond layer) and, in some configurations, one or more additional layers (e.g., a glass prefilter layer, a synthetic prefilter layer, a meltblown layer, a scrim). Such configurations may be useful in, for example, fuel applications.

In yet another exemplary set of embodiments, the filter media may be used in a HEPA application and comprises a support layer (e.g., comprising a wetlaid and/or drylaid layer) and a fine fiber layer deposited on the support layer. In some embodiments, a third layer (e.g., a meltblown layer) is disposed on the fine fiber layer.

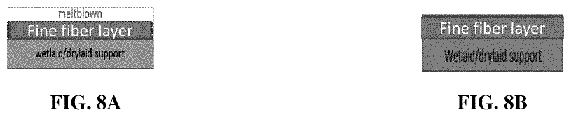

For example, FIGS. 8A-8B show exemplary configurations of filter media comprising a fine fiber layer (e.g., comprising polyamide 11 fibers, electrospun fibers) and a support layer adjacent the fine fiber layer (e.g., a wetlaid and/or drylaid support layer) and, in some configurations, optionally one or more additional layers (e.g., a meltblown layer). Such configurations may be useful in, for example, HEPA applications.

Other combinations of layers and applications are also possible.

### EXAMPLES

### Example 1

The following example demonstrates the superior filtration particle efficiency and fuel water separation for fuel filters and fuel water separators of exemplary filter media, as described herein. Filter media were fabricated with a fine fiber layer comprising a plurality of fibers and a wetlaid backer layer. The plurality of fibers comprised a bio-based polymer polyamide 11.

Each filter media was formed by electrospinning a polymer solution comprising a bio-based polymer polyamide 11 onto a wetlaid backer layer to form a layer comprising plurality of fibers comprising the polyamide 11 polymer disposed on the wetlaid backer layer. A comparative (control) filter media was formed by the same process, except that the polymer solution that was electrospun (and the resulting plurality of fibers) comprised polyamide 6 instead of polyamide 11.

After filter media formation, a variety of properties of each filter media and the layer comprising the plurality of fibers therein were measured by techniques described elsewhere herein. These properties are summarized in Table 1.

As shown in Table 1, filter media having polyamide 11 plurality of fibers had a high filtration efficiency and similar air permeability. Polyamide 6 filter media generally had a much higher maximum pressure drop during fuel-water separation efficiency testing than the polyamide 11 media. Without wishing to be bound by theory, the high hydrophilicity of control polyamide 6 filter media and water absorption rate of polyamide 6 (as compared to the hydrophobic polyamide 11) may contribute to differences observed in pressure drop. Polyamide 11 fibers also generally exhibit significantly higher void volume as compared to polyamide 6 fibers. Advantageously, and without wishing to be bound by theory, this higher void volume likely helped filter media with polyamide 11 fibers to have lower pressure drop compared to control media with polyamide 6 filter media.

TABLE 1

| | | POLYAMIDE |
|---|---|---|
| Fine fiber layer composition | PA6 (control) | 11 |
| Air permeability (CFM) | 3.75 | 3.53 |
| Mean fiber diameter (nm) | 103 | 240 |
| Mean pore diameter (um) | 0.39 | 0.73 |
| Void Volume (%) | <70 | >85 |
| Initial contact angle (degrees) | 46 | >100 |
| Initial efficiency at 1.5 um | 97.5 ± 2.2% | 99.35 |
| (ISO 19438, fine test dust) | | |
| Fuel-water separation efficiency | 92.8% | >95% |
| (SAEJ1488) | | |
| Maximum pressure drop (mm H2O) | >200 (failed | 30 |
| during fuel water test (SAEJ1488) | because of higher | |
| | pressure drop) | |

### Example 2

The following example demonstrates the improves toughness and elongation of Polyamide 11 plurality of fibers compared to control fibers.

Generally, a free-standing layer comprising plurality of fibers comprising polyamide 11 was fabricated. The free-standing layer was formed by electrospinning a polymer solution comprising the polyamide 11 onto wax paper at constant humidity and electric field. The resultant free-standing layer had a basis weight of approximately 5 gsm. A comparative (control) free-standing layer was also formed by this same process, except that the polymer solution that was electrospun and the resulting plurality of fibers comprised materials other than polyamide 11 (as indicated in Table 2).

After electrospinning, each free-standing layer was removed from the wax paper and cut to form a 1″ by 7″ sample, which was loaded into a Thwing-Albert tensile tester equipped with a 20 N load cell. This tensile tester was employed to measure the percent elongation at break and specific tensile strength of each free-standing layer as described elsewhere herein.

Table 2, below, summarizes the relevant properties of each free-standing layer. As shown in Table 2, the free-standing layer comprising polyamide 11 had a larger percent elongation at break than the control free-standing layers and had a similar or higher specific tensile strength compared to the other control free-standing layers.

TABLE 2

| | % elongation | spec. tensile |
|---|---|---|
| polymer | at break | strength (gf/gsm) |
| Polyamide 6 | 30 | 70 |
| Polyamide 11 | 70 | 70 |
| Polyvinylidene | 50 | 35 |
| Fluoride | | |
| Polyethersulfone | 5 | 20 |

### Example 3

The following example demonstrates the ability of polyamide 11 filter media to withstand robust flow and pressure hydraulic filtration conditions compared to comparative filter media. Filter media were prepared comprising a layer comprising plurality of fibers, a wetlaid backer layer, and a scrim. The plurality of fibers comprised a bio-based polymer polyamide 11, wetlaid backer layer comprised synthetic fibers, and the scrim was a spunbond layer.

A procedure as described in Example 1 was employed to form the filter media, except that the wetlaid backer layer comprised synthetic fibers instead of fibers comprising cellulose. This same procedure was also used to form a comparative (control) filter media, except that: (1) the solution that was electrospun to form the layer comprising plurality of fibers and the resulting plurality of fibers comprised polyamide 6 instead of a polyamide 11 polymer; and (2) the wetlaid backer layer comprised synthetic fibers instead of fibers comprising cellulose.

The overall micron rating for a beta 200 efficiency of each filter media were assessed as described elsewhere herein for both filter media. Table 3, below, summarizes the results. As can be seen from Table 3, the filter media including the layer comprising plurality of fibers comprising the polyamide 11 polymer had a lower micron rating for a beta 200 efficiency (i.e. a higher efficiency) than the comparative filter media. These results evidence the failure of the comparative filter media during the test, which caused a large, early drop in performance during the test. Polyamide 11 filter media were generally more robust (as shown in Table 2), able to withstand high pressure during the test, without being damaged. Filter Media 1 and Filter Media 2 demonstrated desirable beta 200 efficiency for both relatively low and relatively higher air permeability.

TABLE 3
Test results for hydraulic media comprising fine fiber layers

| | | | Control |
|---|---|---|---|
| | Filter | Filter | Filter |
| Sample | Media 1 | Media 2 | Media |
| Polymer in layer | Polyamide 11 | Polyamide 11 | Polyamide 6 |
| including plurality | (as described | (as described | |
| of fibers | above) | above) | |
| Overall micron rating | <1 | 8.8 | 20 |
| for a beta 200 | | | |
| efficiency of the filter | | | |
| media (microns) | | | |
| Air Permeability | 21.5 | 36 | 23 |
| (CFM) | | | |

### Example 4

The following example demonstrates the superior fuel water separation and superior filtration particle efficiency of exemplary filter media, as described herein. Filter media were fabricated comprising a layer comprising plurality of fibers and a wetlaid backer layer. The plurality of fibers comprised a bio-based polymer polyamide 11.

Each filter media was formed by electrospinning a polymer solution comprising a bio-based polymer polyamide 11 onto a wetlaid backer layer to form a layer comprising plurality of fibers comprising the polyamide 11 polymer disposed on the wetlaid backer layer with a laminated meltblown layer, on top. Comparative cellulose composite filter media was formed on a wetlaid machine with a laminated scrim on the top. Comparative glass composite filter media was formed in a similar way on a wetlaid machine comprising glass and cellulose fibers with a laminated scrim, on the top.

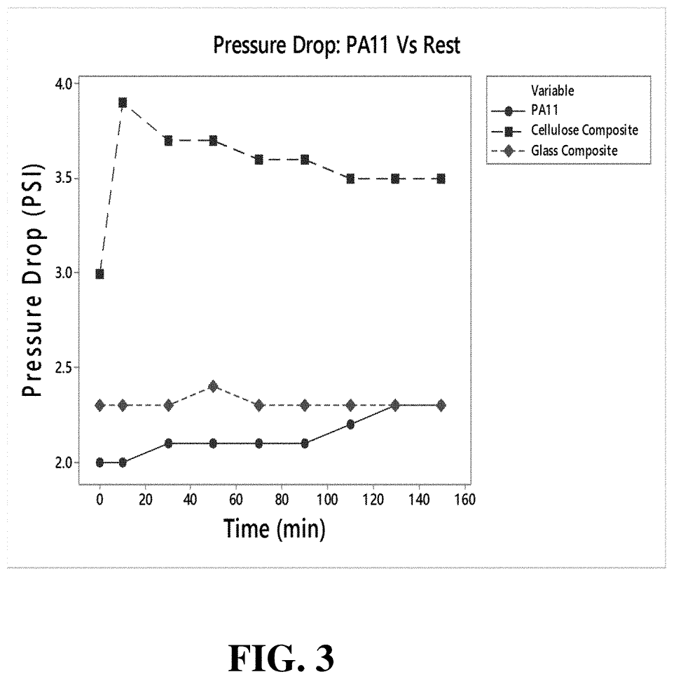

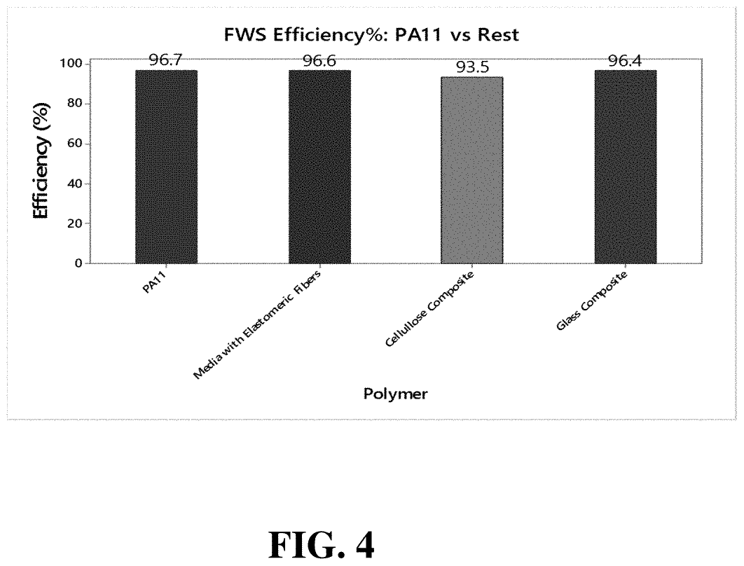

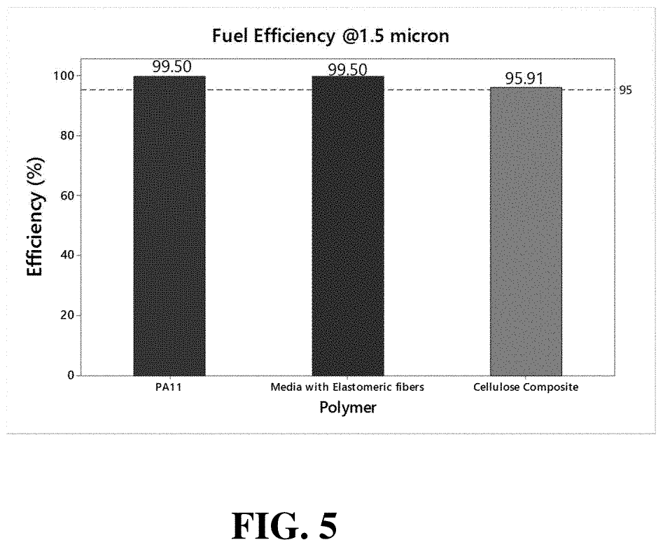

After filter media formation, a variety of properties of each filter media and the layer comprising the plurality of fibers therein were measured by techniques described elsewhere herein. These properties are summarized in Table 4. Also all the three filter media's described above were subjected to Fuel Water Separation (FWS) efficiency and Fuel efficiency test. FIG. 3, shows the pressure drop of each filer media during the FWS test. FIG. 4, shows Fuel Water Separation (FWS) efficiency of the comparative filter media. FIG. 5, shows fuel efficiency @1.5 micron for the filter media.

During the FWS efficiency test, pressure drop of the media increases with time, as water is being separated. Without wishing to be bound by theory, pressure drop can also be high if there is a swelling of fibers (e.g., as observed with polyamide 6, in Example 1). Fine fiber layers comprising polyamide 11 do not swell substantially (e.g., polyamide 11 fibers are generally moisture resistant and hydrophobic) as compared to polyamide 6 fibers. As shown in FIG. 3, filter media with polyamide 11 fibers have substantially lower pressure drop compared to comparative filter media, described above. Advantageously, without wishing to be bound by theory, the lower pressure drop helps increase the life time of the filter media.

Advantageously, filter media with polyamide 11 fibers, though having a lower pressure drop, does not demonstrate a substantial compromise on the efficiency. As shown in FIGS. 4-5, filter media with polyamide 11 fibers have better or similar FWS and Fuel efficiency compared to comparative media described above. Filter media with polyamide 11 fibers had lower pressure drop and improved filtration efficiency, at lower basis weight and lower thickness as compared to comparative filter media. In addition, filter media with polyamide 11 plurality of fibers had a lower pore size compared to the comparative filter media.

TABLE 4

| | | Cellulose | Glass |
|---|---|---|---|
| | Polyamide 11 | Composite | Composite |
| Properties | Filter Media | Filter Media | Filter Media |
| Basis Weight | 171 | 198 | 260 |
| (g/m2) | | | |
| Thickness (mm) | 0.75 | 0.74 | 1.29 |
| Air Permeability | 3.5 | 2 | 5.3 |
| (CFM) | | | |
| Mean Pore | 0.7 | 1.4 | 3.2 |
| diameter (um) | | | |
| Configuration | Cellulose/ | Cellulose/scrim | Cellulose/glass/ |
| | Polyamide 11/ | | scrim |
| | Meltblown | | |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in some embodiments, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in some embodiments, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The term “amine” is given its ordinary meaning in the art and refers to a primary (—NH₂), secondary (—NHRₓ), tertiary (—NRₓR_{y}), or quaternary (—N⁺RₓR_{y}R_{z}) amine (e.g., where Rₓ, R_{y}, and R_{z} are independently an aliphatic, alicyclic, alkyl, aryl, or other moieties, as defined herein).

The term “amide” is given its ordinary meaning in the art and refers to a compound containing a nitrogen atom and a carbonyl group of the structure R_{X}CONR_{y}R_{z} (e.g., where Rₓ, R_{y}, and R_{z} are independently an aliphatic, alicyclic, alkyl, aryl, or other moieties, as defined herein).

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, and/or geometric relationship include, but are not limited to terms descriptive of: shape—such as, round, square, circular/circle, rectangular/rectangle, triangular/triangle, cylindrical/cylinder, elliptical/ellipse, (n)polygonal/(n)polygon, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; direction—such as, north, south, east, west, etc.; surface and/or bulk material properties and/or spatial/temporal resolution and/or distribution—such as, smooth, reflective, transparent, clear, opaque, rigid, impermeable, uniform(ly), inert, non-wettable, insoluble, steady, invariant, constant, homogeneous, etc.; as well as many others that would be apparent to those skilled in the relevant arts. As one example, a fabricated article that would described herein as being “ square” would not require such article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described. As another example, two or more fabricated articles that would described herein as being “aligned” would not require such articles to have faces or sides that are perfectly aligned (indeed, such an article can only exist as a mathematical abstraction), but rather, the arrangement of such articles should be interpreted as approximating “aligned,” as defined mathematically, to an extent typically achievable and achieved for the recited fabrication technique as would be understood by those skilled in the art or as specifically described.

What is claimed is:

1. A filter media, comprising:
a fine fiber layer comprising a plurality of electrospun fibers, the electrospun fibers comprising polyamide 11; and
a support layer adjacent the fine fiber layer.

2. A filter media, comprising:
a fine fiber layer comprising a plurality of fibers comprising polyamide 11; and
a support layer adjacent the fine fiber layer, wherein
the plurality of fibers comprising polyamide 11 have an average diameter of less than or equal to 1.5 microns.

3. A filter media, comprising:
a fine fiber layer comprising a plurality of fibers comprising polyamide 11, the fine fiber layer having a solidity of greater than or equal to 10.

4. A filter media as in claim 1, wherein the fine fiber layer has a mean pore diameter of greater than or equal to 0.1 microns and less than or equal to 1.5 micron.

5. A filter media as in claim 1, wherein the fine fiber layer has a maximum pore diameter of greater than or equal to 1 and less than or equal to 10 microns.

6. A filter media as in claim 1, wherein the fine fiber layer is hydrophobic.

7-9. (canceled)

10. A filter media as in claim 1, wherein the support layer comprises a plurality of fibers selected from the group consisting of cellulose, synthetic fibers, glass fibers, and combinations thereof.

11-26. (canceled)

27. A hydraulic filtration component, comprising a filter media as in claim 1.

28. A fuel filtration component, comprising a filter media as in claim 1.

29. A heating ventilation and air conditioning (HVAC) filtration component, comprising a filter media as in claim 1.

30. A high-efficiency particular air (HEPA) filtration component, comprising a filter media as in claim 1.

31. A filter media as in claim 1, wherein the filter media has a pressure drop across the entire filter media of greater than or equal to about 0.05 kPa and less than or equal to about 80 kPa.

32. A filter media as in claim 1, wherein the filter media has an air permeability of greater than or equal to 0.1 CFM and less than or equal to 300 CFM.

33. A filter media as in claim 1, wherein the filter media has a micron rating for beta efficiency of greater than or equal to 0.1 microns and less than or equal to 30 microns.

34. A filter media as in claim 1, wherein the filter media has a fuel-water separation efficiency of greater than or equal to 20% and less than or equal to 99.9%.

35. A filter media as in claim 1, wherein the filter media has an average fuel efficiency of greater than or equal to 10% and less than or equal to 100%.

36. A filter media as in claim 1, wherein the filter media has an overall mean flow pore size of greater than or equal to 0.05 μm and less than or equal to 200 μm.

37. (canceled)

38. A filter media as in claim 1, wherein the filter media has an overall thickness of greater than or equal to 0.03 mm and less than or equal to 30 mm.

39. A filter media as in claim 1, wherein the filter media has a basis weight of greater than or equal to 2 g/m² and less than or equal to 1000 g/m².

40. A filter media as in any preceding claim, wherein the filter media has a BET surface area of greater than or equal to 0.01 m²/g and less than or equal to 400 m²/g.

41-45. (canceled)
